(19) United States
(12) Patent Application Publication
(10) Pub. No.: US 2012/0307280 A1
(43) Pub. Date: Dec. 6, 2012

(54) IMAGE PROCESSING SYSTEM THAT TRANSFERS IMAGE DATA TO SERVER APPARATUS, INFORMATION PROCESSING APPARATUS, METHOD OF CONTROLLING THE INFORMATION PROCESSING APPARATUS, AND STORAGE MEDIUM

(75) Inventor: Tomohiro Ishihara, Kawasaki-shi (JP)

(73) Assignee: CANON KABUSHIKI KAISHA, Tokyo (JP)

(21) Appl. No.: 13/483,149

(22) Filed: May 30, 2012

(30) Foreign Application Priority Data
Jun. 1, 2011 (JP) 2011-123643

(51) Int. Cl. G06K 15/02

(52) U.S. Cl. 358/1.13

(57) ABSTRACT

An arrangement that reduces the burden on a user for transferring image data to one or more server apparatuses. An image processing system includes a first server which stores image data transferred via an information processing apparatus, and a second server which stores image data to be transferred to the first server. The first server provides an access script to the apparatus, for use in accessing the second server. The second server provides a list of stored image data items and a transfer script for use in transferring image data to the first server, to the apparatus. When requested to provide image data selected from the list, the second server provides the requested image data to the apparatus. The apparatus transfer the image data provided by the second server to the first server.

### BACKGROUND OF THE INVENTION

1. Field of the Invention

The present invention relates to an image processing system for transferring image data using a network, an information processing apparatus, a method of controlling the information processing apparatus, and a storage medium.

2. Description of the Related Art

To use a peripheral apparatus, such as an image input apparatus, from an information processing apparatus, generally, it is necessary to install a specific device driver compatible with the peripheral apparatus (e.g. a scanner driver in the case of an image input apparatus) in an operating system (hereinafter referred to as the “OS”) which operates on the information processing apparatus.

When using an image input apparatus, a scanner driver is started from an application, settings necessary for a scanning operation are made, the image input apparatus is driven, and then acquired image data is transferred to the application, whereby the application is enabled to freely handle the image data.

Therefore, conventionally, it is required that scanner drivers have been made available each of which is compatible with both of an image input apparatus to be used and an OS operating on an information processing apparatus. This generates a situation in which a user is required to search for a proper scanner driver which operates in a manner compatible with a combination of an OS and an image input apparatus.

Further, users are sometimes required to perform a troublesome work, such as installation of a scanner driver into the OS. On the other hand, manufacturers and sellers of image input apparatuses are required to supply scanner drivers compatible with OS types which have been recently increased in number. Thus, the work for coping with the necessity of installing an appropriate driver is ever increasing.

On the other hand, there has been proposed a method of realizing a function equivalent to the operation of a scanner driver by accessing a Web page hosted by a PC (personal computer) which is directly connected to an image input apparatus, instead of using the scanner driver (see e.g. Japanese Patent Laid-Open Publication No. 2000-148649).

In this case, the information processing apparatus which accesses the web page is not required to have a scanner driver installed therein.

Further, in recent years, a wide range of various uses of images have been made possible through image processing by so-called cloud computing, which is provided by a web service application operating on server apparatuses on the Internet.

As a method of transferring an image to a server apparatus on the Internet, the following technique is used: An image file is transferred from an information processing apparatus being in use to a desired server apparatus, using a menu option of e.g. image upload, which is integrated in a web page opened by a web browser application of the information processing apparatus. Image file transfer by a dedicated application for file transfer is also widely used.

In an image input system using a web browser, disclosed in Japanese Patent Laid-Open Publication No. 2000-148649, a server apparatus connected to the image input apparatus, i.e. the aforementioned PC, is required to be provided within a local network so as to construct the image input system. Further, the image input system is required to be provided with settings with which the image input apparatus is driven by a scanner driver of an OS or the like mechanism.

Further, when an information processing apparatus, such as a mobile terminal, does not have a memory capacity sufficient to receive an image, it is impossible to store the whole image data scanned via a web page in the information processing apparatus, which is described in Japanese Patent Laid-Open Publication No. 2000-148649. Further, when image data is stored in a server apparatus, a new mechanism and operation is necessary for retrieving the image data after the storage operation, which is different from scan processing.

To solve the above-mentioned problems, it is possible to envisage the following image input system: First, an image input service provided by a server apparatus on the Internet is started by a web browser operating on an information processing apparatus.

Then, the information processing apparatus downloads a script from the server apparatus and executes the script. Further, the information processing apparatus transmits (broadcasts) a search protocol-based message to the local network to thereby search for an image input apparatus, and then transfers information on the image input apparatus found by the search to the server apparatus. After that, the information processing apparatus transfers a scan command signal transmitted from the server apparatus to the image input apparatus, whereby the image input apparatus performs scan processing and transmission processing for transmitting image information. The information processing apparatus transfers the image information transmitted from the image input apparatus to the server apparatus.

This makes it possible construct an image input system which can operate with the information processing apparatus without a sufficient local storage capacity and makes it possible to make use of a wide range of storage functions on the Internet, without requiring complicated settings to be made for the server apparatus and the like in advance.

However, in the image input system, when the same image information is transmitted to a plurality of web services on the Internet, the image data cannot be locally stored, and hence there arises the following inconvenience:

A sequence of operations from the start of an image input service to the transmission of a scanned image is repeated the number of times corresponding to the number of server apparatuses which request image transmission, demanding increased user's time and effort. Further, since the scan operation is repeated a plurality of times, the user occupies the image input apparatus for a long time, which hinders the other users who desire to use the image input apparatus from performing image input operations.

As described above, the conventional technique has a problem that the burden on a user is heavy when transferring image data to one or more server apparatuses.

### SUMMARY OF THE INVENTION

The present invention provides an arrangement that reduces the burden on a user for transferring image data to one or more server apparatuses.

In a first aspect of the present invention, there is provided an image processing system including a first server apparatus which stores image data transferred via an information processing apparatus, and a second server apparatus which stores image data to be transferred to the first server apparatus, wherein the first server apparatus comprises an access script-providing unit configured to provide an access script to the information processing apparatus, for use in accessing the second server apparatus, and a storage unit configured to store image data transferred from the information processing apparatus, wherein the second server apparatus comprises a first list-providing unit configured to provide a list of stored image data items to the information processing apparatus, and an image data-providing unit configured to be operable when requested to provide an image data item selected from the list provided by the first list-providing unit, to provide the requested image data item to the information processing apparatus, and wherein the information processing apparatus comprises an access unit configured to access the second server apparatus according to the access script provided by the access script-providing unit, a selection unit configured to select an image data item from the list of image data items provided by the first list-providing unit, and a transfer unit configured to transfer the image data item provided by the image data-providing unit to the first server apparatus.

In a second aspect of the present invention, there is provided an information processing apparatus that receives image data from a second server apparatus storing image data to be transferred to a first server apparatus storing image data, and transfers the received image data to the first server apparatus, comprising an access script acquisition unit configured to acquire, from the first server apparatus, an access script for accessing the second server apparatus, a list acquisition unit configured to access the second server apparatus using the access script acquired by the access script acquisition unit, and acquire a list of image data items stored in the second server apparatus, a transfer script acquisition unit configured to acquire, from the second server apparatus, a transfer script for use in acquiring an image data item to be transferred to the first server apparatus from the list of image data items acquired by the list acquisition unit to thereby transfer the acquired image data item, and a transfer unit configured to acquire the image data item stored in the second server apparatus and transfer the acquired image data item to the first server apparatus, using the transfer script acquired by the transfer script acquisition unit.

In a third aspect of the present invention, there is provided a method of controlling an information processing apparatus that receives image data from a second server apparatus storing image data to be transferred to a first server apparatus storing image data, and transfers the received image data to the first server apparatus, comprising acquiring, from the first server apparatus, an access script for accessing the second server apparatus, accessing the second server apparatus using the acquired access script, and acquiring a list of image data items stored in the second server apparatus, acquiring, from the second server apparatus, a transfer script for use in acquiring an image data item to be transferred to the first server apparatus from the acquired list of image data items to thereby transfer the acquired image data item, and acquiring the image data item stored in the second server apparatus and transferring the acquired image data item to the first server apparatus, using the acquired transfer script.

In a fourth aspect of the present invention, there is provided a non-transitory computer-readable storage medium storing a computer-executable program for executing a method of controlling an information processing apparatus that receives image data from a second server apparatus storing image data to be transferred to a first server apparatus storing image data, and transfers the received image data to the first server apparatus, wherein the method comprises acquiring, from the first server apparatus, an access script for accessing the second server apparatus, accessing the second server apparatus using the acquired access script, and acquiring a list of image data items stored in the second server apparatus, acquiring, from the second server apparatus, a transfer script for use in acquiring an image data item to be transferred to the first server apparatus from the acquired list of image data items to thereby transfer the acquired image data item, and acquiring the image data item stored in the second server apparatus and transferring the acquired image data item to the first server apparatus, using the acquired transfer script.

According to the present invention, it is possible to provide an arrangement that reduces the burden on a user for transferring image data to one or more server apparatuses.

Further features of the present invention will become apparent from the following description of exemplary embodiments with reference to the attached drawings.

### BRIEF DESCRIPTION OF THE DRAWINGS

FIG. 1 is a schematic block diagram of an image processing system according to an embodiment of the present invention.

FIG. 2 is a block diagram of an information processing apparatus and an image input apparatus, appearing in FIG. 1.

FIG. 3 is a block diagram of a server apparatus appearing in FIG. 1.

FIGS. 4A and 4B are sequence diagrams of a scanning process executed by the server apparatus, the information processing apparatus, and the image input apparatus, appearing in FIG. 1.

FIG. 5 is a sequence diagram of a scanning process using a history image, which is executed by the server apparatus, the information processing apparatus, and the image input apparatus, appearing in FIG. 1.

FIG. 6 is a view showing an example of an input image selection screen.

FIG. 7 is a view showing an example of a search-in-progress screen.

FIG. 8 is a view showing an example of an image input apparatus selection screen.

FIG. 9 is a view showing an example of a scan setting screen.

FIG. 10 is a view showing an example of a scan-in-progress screen.

FIG. 11 is a view showing an example of a scan operation completed screen.

FIGS. 12A to 12C are a flowchart of a scanning process executed by the information processing apparatus appearing in FIG. 1.

FIGS. 13A to 13C are a flowchart of a scanning process executed by the server apparatuses appearing in FIG. 1.

FIG. 14 is a flowchart of a scanning process executed by the image input apparatus appearing in FIG. 1.

FIG. 15 is a diagram showing an example of data transmission and reception performed according to a search script and a scan script when the search script and the scan script of the server apparatus are executed on a web browser of the information processing apparatus, and contents of transmitted and received data.

### DESCRIPTION OF THE EMBODIMENTS

The present invention will now be described in detail below with reference to the accompanying drawings showing embodiments thereof.

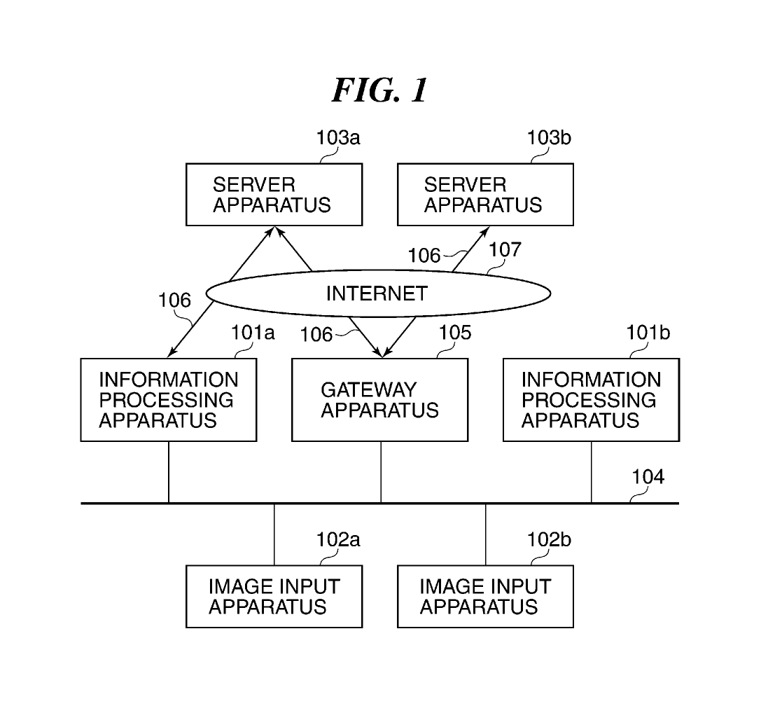

FIG. 1 is a schematic block diagram of an image processing system according to an embodiment of the present invention.

In FIG. 1, the image processing system includes information processing apparatuses 101a and 101b, image input apparatuses 102a and 102b, a gateway apparatus 105, and server apparatuses 103a and 103b. In the following, in providing a description applicable to both of the information processing apparatuses 101a and 101b, the information processing apparatuses 101a and 101b are referred to as the information processing apparatuses 101. Similarly, in providing a description applicable to both of the image input apparatuses 102a and 102b, the image input apparatuses 102a and 102b are referred to as the image input apparatuses 102. Also similarly, in providing a description applicable to both of the server apparatuses 103a and 103b, the server apparatuses 103a and 103b are referred to as the server apparatuses 103. Further, although the two information processing apparatuses 101, the two image input apparatuses 102, and the two server apparatuses 103 are shown in FIG. 1, these are examples, and the numbers of them are not limited to two.

The information processing apparatuses 101 and the image input apparatuses 102 are connected via a local network 104 constructed by Ethernet (registered trademark). Further, the server apparatus 103a is connected to the information processing apparatus 101a via a network 106 including a mobile communication network, public lines, the Internet 107 and the like, or via the network 106 and the gateway apparatus 105. Further, the server apparatus 103b is connected to the information processing apparatuses 101 via the network 106 and the gateway apparatus 105. Therefore, the server apparatuses 103, the information processing apparatuses 101, and the image input apparatuses 102 can communicate with each other.

The image input apparatus 102 transmits image data to the information processing apparatus 101, and also performs scanning.

In the present embodiment, the image input apparatus 102 is configured to transmit image data obtained by scan processing to the information processing apparatus 101, and the server apparatus 103 is configured to receive the image data from the information processing apparatus 101.

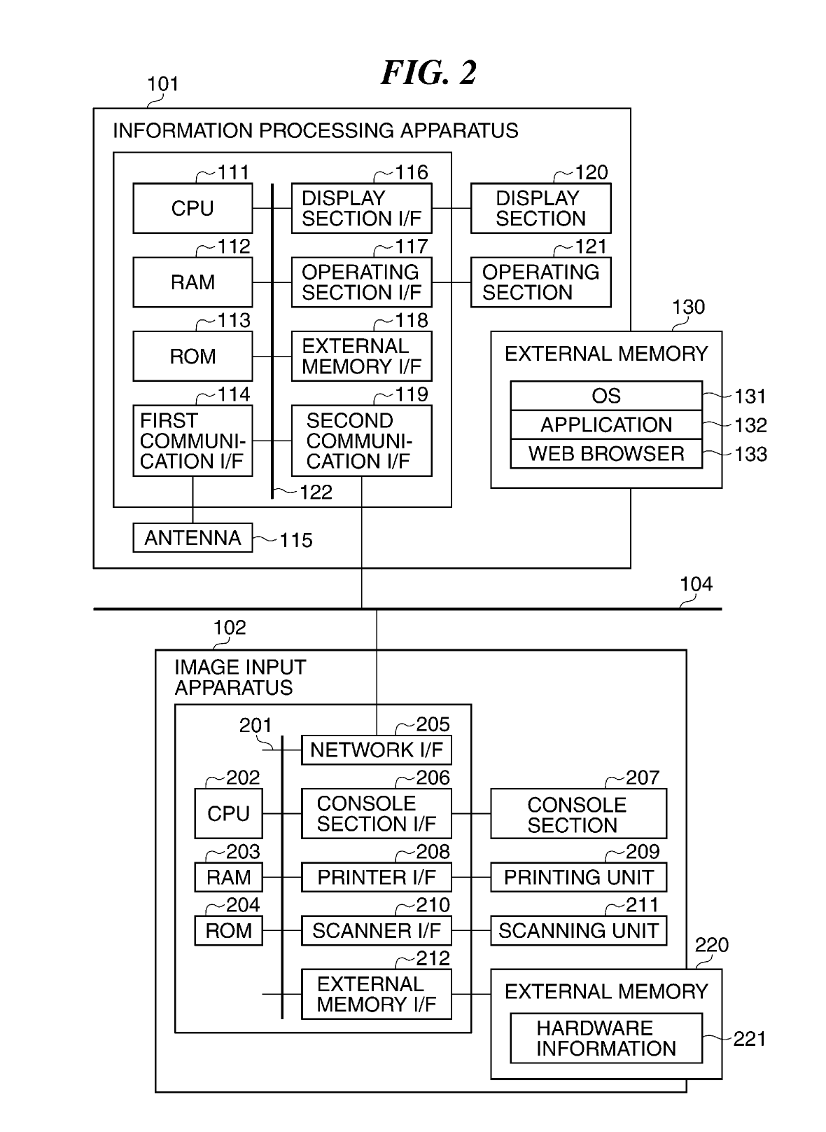

FIG. 2 is a block diagram of the information processing apparatus 101 and the image input apparatus 102, appearing in FIG. 1.

In FIG. 2, a CPU 111 of the information processing apparatus 101 controls the overall operation of devices connected to a system bus 122 according to programs stored in a RAM 112. The RAM 112 further functions as a main memory, a work area, and so forth, for the CPU 111.

A ROM 113 stores various kinds of programs and data. An operating section interface 117 controls key inputs from an operating section 121 or a pointing device (e.g. a touch panel), not shown.

A display section interface 116 controls contents to be displayed on a display section 120. An external memory interface 118 controls access to an external memory 130, such as a flash memory or an SSD (solid state disk).

The external memory 130 functions as a storage medium in which the information processing apparatus can store data or from which the information processing apparatus can read data. More specifically, the external memory 130 stores an OS (operating system) 131, various kinds of applications 132, and a web browser 133.

A first communication interface 114 is a controller for communication e.g. via a mobile network, and establishes a network connection to a wireless base station via an antenna 115. A second communication interface 119 is a controller for a Wi-Fi wireless network and a preferred network, and enables connection to a local network via a Wi-Fi antenna or a network terminal, not shown.

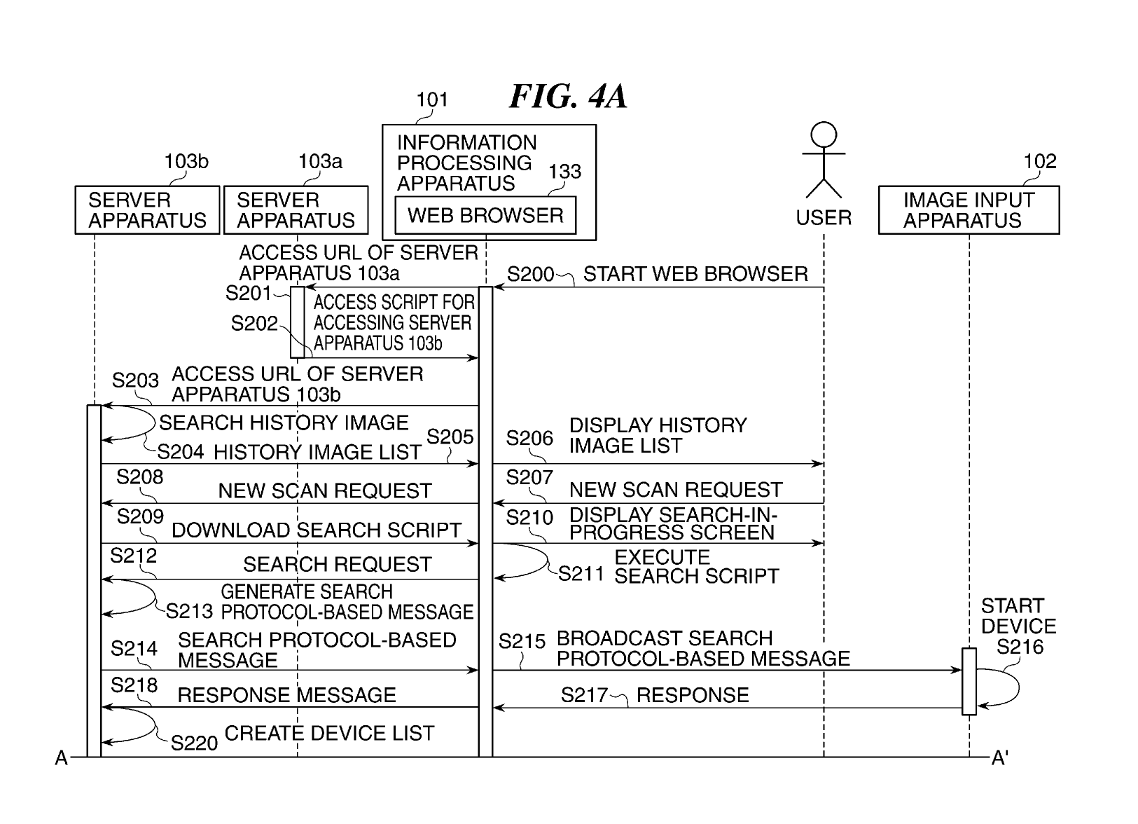

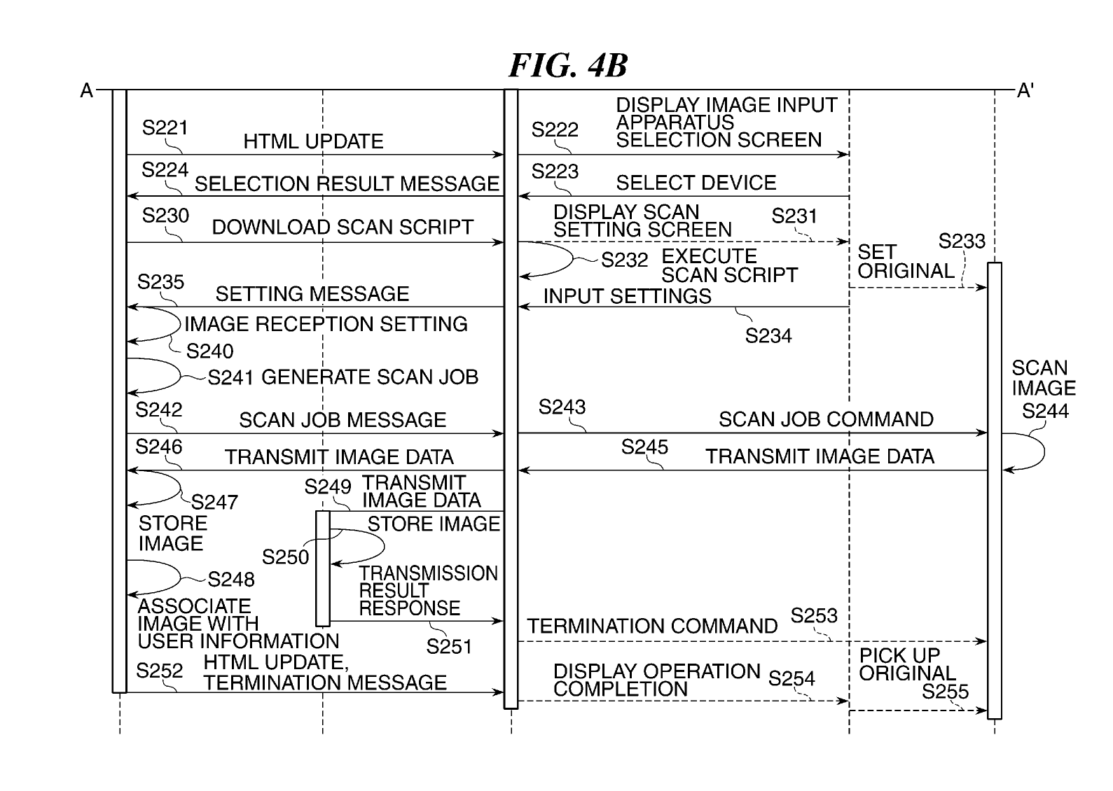

Note that a script file which is executed on the web browser 133 is not initially stored in the external memory 130 of the information processing apparatus 101 which is newly used by a user. In the present embodiment, if a script file according to which the scan system environment is constructed is not stored, the web browser 133 running on the OS 131 downloads a script from the server apparatus 103 into the information processing apparatus 101 and executes the script using the RAM 112. Details of an example of script execution processing by the web browser 133 will be described with reference to FIGS. 4A and 4B.

Next, a description will be given of the configuration of the image input apparatus 102. A CPU 202 controls the overall operation of the image input apparatus 102. A RAM 203 functions as a main memory, a work area, and so forth, for the CPU 202, and is also used as an input information-loading area and an environment data-storing area. Further, the RAM 203 has a NVRAM (nonvolatile RAM) area, and is configured to be capable of expanding a memory capacity by an option RAM connected to an expansion port, not shown.

A ROM 204 stores various types of fonts, control programs and the like executed by the CPU 202, and various kinds of data. A network interface 205 transmits and receives data to and from the information processing apparatus 101.

A printer interface 208 controls interface with a printing unit 209 which is a printer engine. A scanner interface 210 controls interface with a scanning unit 211 which is a scanner engine.

An external memory 220 stores hardware information 221. An external memory interface 212 controls access to the external memory 220, and the external memory 220 includes a flash memory, an SSD, etc. Note that when the external memory 220 is not connected, the image input apparatus 102 stores information etc. used in the information processing apparatus 101, in the ROM 204.

A console section interface 206 controls interface with a console section 207 from which the scan processing to be performed by the image input apparatus 102 is set. The console section 207 is provided with an operating panel for receiving input operations by a user. Switches, an LED display device, etc. for the input operations are arranged on the operating panel. Further, the console section 207 may include an NVRAM, not shown, to store scan setting information input from the operating panel. The above-mentioned sections are connected by a system bus 201.

With the above-described configuration, the CPU 202 acquires image data from the scanning unit 211 via the scanner interface 210 based on the control program and the like stored in the ROM 204. Further, the CPU 202 is capable of performing processing for communicating with the information processing apparatus 101 via the network interface 205. The CPU 202 is configured to be capable of transmitting image data to the information processing apparatus 101, and notifying the information processing apparatus 101 of information and the like stored in the image input apparatus 102. In the present embodiment, the network interface 205 implements a corresponding web service protocol.

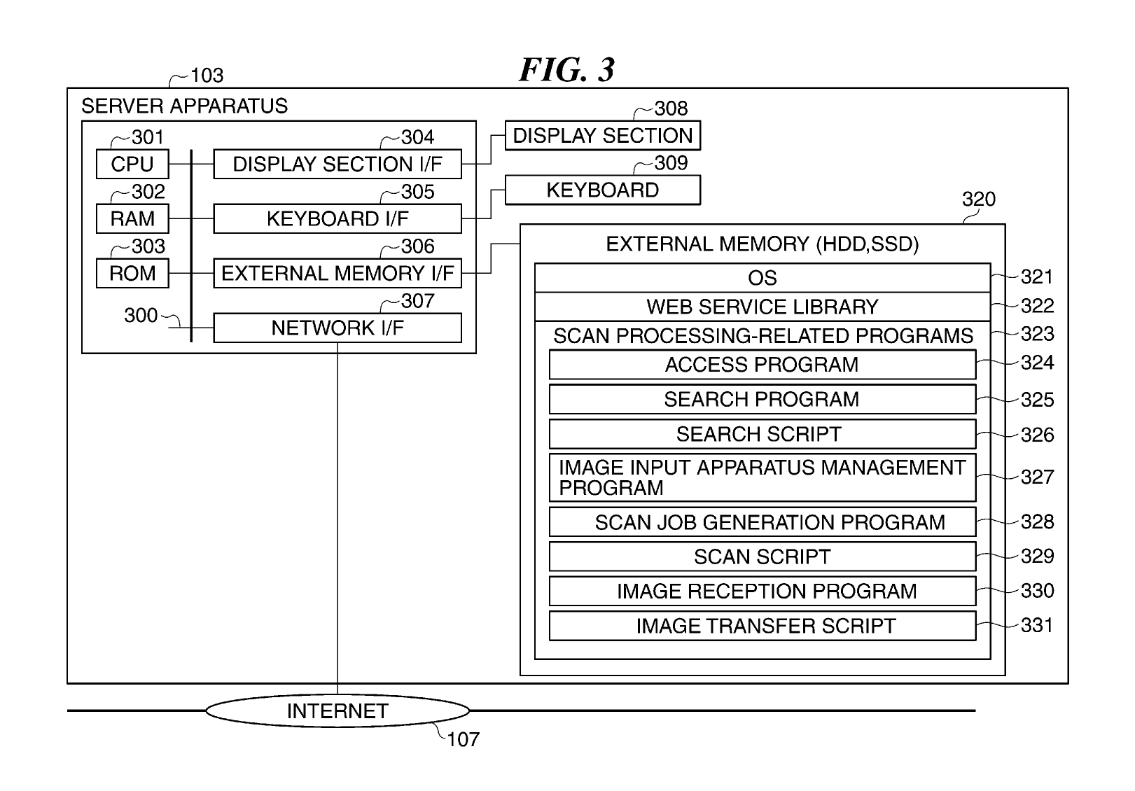

FIG. 3 is a schematic block diagram of the server apparatus 103 appearing in FIG. 1.

In the present embodiment, two types of the server apparatuses 103 exist. One is for providing an image input service and is denoted as the server apparatus 103a in the present embodiment. The other is for storing history images and is denoted as the server apparatus 103b in the present embodiment. The following description will be given of the server apparatus 103b.

In FIG. 3, a CPU 301 controls the overall operation of devices connected to a system bus 300 according to programs stored in a RAM 302. The RAM 302 further functions as a main memory and a work area and the like, for the CPU 301. A ROM 303 stores various kinds of programs and data. A keyboard interface 305 controls key inputs from a keyboard 309 or a pointing device, such as a mouse, not shown.

A display section interface 304 controls contents to be displayed on a display section 308. An external memory interface 306 controls access to an external memory 320, such as a hard disk (HD) or an SSD.

The external memory 320 stores an OS 321, a web service library 322, and various kinds of scan processing-related programs 323, and further stores user files, edited files, and so on, not shown.

Of the above-mentioned stored programs and files, the scan processing-related programs 323 include an access program 324, a search program 325, a search script 326, an image input apparatus management program 327, and a scan job generation program 328.

The scan processing-related programs 323 further include a scan script 329, an image reception program 330, and an image transfer script 331.

A network interface 307 is connected to the information processing apparatus 101 via the Internet 107 or a mobile communication network, and indirectly performs communication control processing with the image input apparatus 102 connected to the information processing apparatus 101.

Although the server apparatus 103a which provides the image input service is not shown, the server apparatus 103a is identical in configuration to the server apparatus 103b in the following points: The server apparatus 103a has the same configuration as the server apparatus 103b in respect of the CPU, the RAM, the system bus, the ROM, the keyboard controller interface, the keyboard, the display section, the external memory interface, the external memory, the OS, and the web service library.

FIGS. 4A and 4B are sequence diagrams of a scanning process without using a history image, including the script execution processing by the web browser 133 of the information processing apparatus 101, which is executed by the server apparatus 103, the information processing apparatus 101, and the image input apparatus 102, appearing in FIG. 1.

The above-mentioned history image is an image that was scanned by a user, and was transmitted to the server apparatus 103 in the past.

Further, in FIGS. 4A and 4B, it is assumed that the web browser 133 of the information processing apparatus 101 is capable of accessing the image input apparatus 102 and the server apparatuses 103a and 103b via the local network 104.

Further, the server apparatus 103a (first server apparatus) stores image data transferred via the information processing apparatus 101, and is used as the server apparatus 103 that provides the image input service. Further, the server apparatus 103b (second server apparatus) is used as the server apparatus 103 that stores history images. Therefore, the combination of the server apparatuses 103a and 103b, appearing in FIG. 1, constitutes the image processing system.

Note that the aforementioned condition of accessibility of the web browser 133 and the configuration of the server apparatuses 103 are assumed to be the same in the following description of the embodiment, as well.

The user starts the web browser 133 using the operating section 121 of the information processing apparatus 101 (step S200). Next, the information processing apparatus 101 accesses the URL of the server apparatus 103a to thereby log into the server apparatus 103a so as to make use of an image input service (step S201).

When the login is successful, a script for accessing the server apparatus 103b, a URL of an image storage destination in the server apparatus 103a, and authentication information of the user are downloaded from the server apparatus 103a to the web browser 133 (step S202).

The downloaded script is executed on the web browser 133, and the web browser 133 accesses the server apparatus 103b (step S203).

The server apparatus 103b searches for history images by checking user information registered in the history image stored therein with information on the accessing user (step S204). The server apparatus 103b transmits a list of the history images found to match with the information on the accessing user by the search operation to the web browser 133 (step S205).

If no history images of the accessing user are found, the process skips steps S205 to S208 and directly proceeds to a step S209.

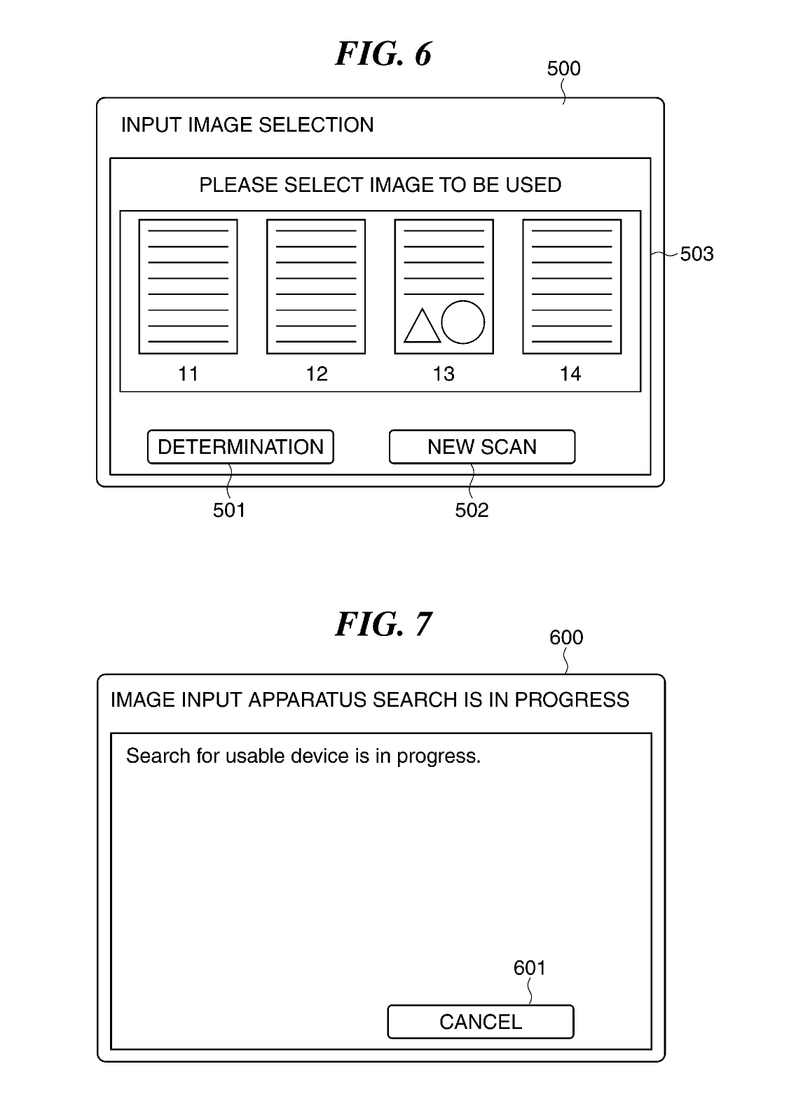

After the step S205, the web browser 133 displays an input image selection screen including the list of history images to the user (step S206), and the user checks the list of the history images to select a history image or a new scan. In the illustrated example, the user selects a new scan and inputs a new scan request to the web browser 133 (step S207). FIG. 6 is a view showing an example of the input image selection screen. Details of the input image selection screen in FIG. 6 will be described hereinafter.

The web browser 133 transmits the new scan request to the server apparatus 103b according to the user's input (step S208). Then, a search script for a scanning system is downloaded from the server apparatus 103b to the web browser 133 (step S209).

The downloaded search script is executed on the web browser 133, and the information processing apparatus 101 displays a search-in-progress screen (step S210). FIG. 7 is a view showing an example of the search-in-progress screen. Details of the search-in-progress screen in FIG. 7 will be described hereinafter.

When the search script is executed, the information processing apparatus 101 sends a search request to the server apparatus 103b (step S212). Note that although not shown, the information processing apparatus 101 periodically transmits an HTML file update request message to the server apparatus 103b during execution of the search script. By transmitting the update message, if there is a change in the status of the server apparatus 103b, the information processing apparatus 101 updates the displayed screen according to the update of the HTML file.

Upon receipt of the search request, the server apparatus 103b creates a search protocol-based message. The created search protocol-based message is transmitted by the search program 325 of the server apparatus 103b to the information processing apparatus 101 (step S214). At this time, the search script executed on the web browser 133 of the information processing apparatus 101 sends the search protocol-based message by broadcast to the local network 104 after executing IP header conversion of packet data of the received search protocol-based message (step S215). An example of the packet data conversion process executed by the search script will be described hereinafter. The step S214 corresponds to an operation of a search unit that searches for an image input apparatus when image data stored in the server apparatus is not used.

Each image input apparatus 102 having received the broadcast search protocol-based message is activated (returns from the sleep state) (step S216). The image input apparatus 102 determines whether or not the self device is compatible with the search protocol-based message. When it is determined that the image input apparatus 102 is compatible with the search protocol-based message, the image input apparatus 102 sends a response to the information processing apparatus 101 which is a broadcast transmission source (step S217).

Thus, all of image input apparatuses 102 on the local network 104 which are compatible with the search protocol-based message each similarly transmit the response back to the information processing apparatus 101.

The search script being executed on the web browser 133 of the information processing apparatus 101 having received responses converts the received responses to response messages, and sequentially transfers the response messages to the server apparatus 103b (step S218). An example of converting processing executed by the search script for converting a response to a response message will be described hereinafter.

According to this search process, further to the above, there is obtained image input apparatus information concerning the image input apparatus 102 found by the broadcast transmission of the search protocol-based message, which includes, for example, a name of the image input apparatus 102, input capability thereof, such as supported resolutions and sheet sizes, and information on the capability of transmission to external apparatuses, such as the server apparatus 103, e.g. SMB (Server Message Block) and WebDAV (Web Distributed Authoring and Versioning). The method of transmitting the search protocol-based message to the local network, which can be employed in the search process is not particularly limited to the broadcast transmission mentioned above. For example, the transmission method also includes multicast transmission as used in SSDP (Simple Service Discovery Protocol) and WSD (Web Service on Devices) discovery.

Next, the image input apparatus management program 327 analyzes response messages transmitted from the information processing apparatus 101 to the server apparatus 103b, and creates a retrieved device list which is a list of the image input apparatuses 102 obtained from the search result (step S220).

The image input apparatus management program 327 converts the result (list) to an HTML file, and performs the HTML update (step S221). The step S221 corresponds to an operation of a second list-providing unit that provides a list of image input apparatuses found by a search to the information processing apparatus.

According to the HTML update, the web browser 133 displays an image input apparatus selection screen including the retrieved device list (step S222).

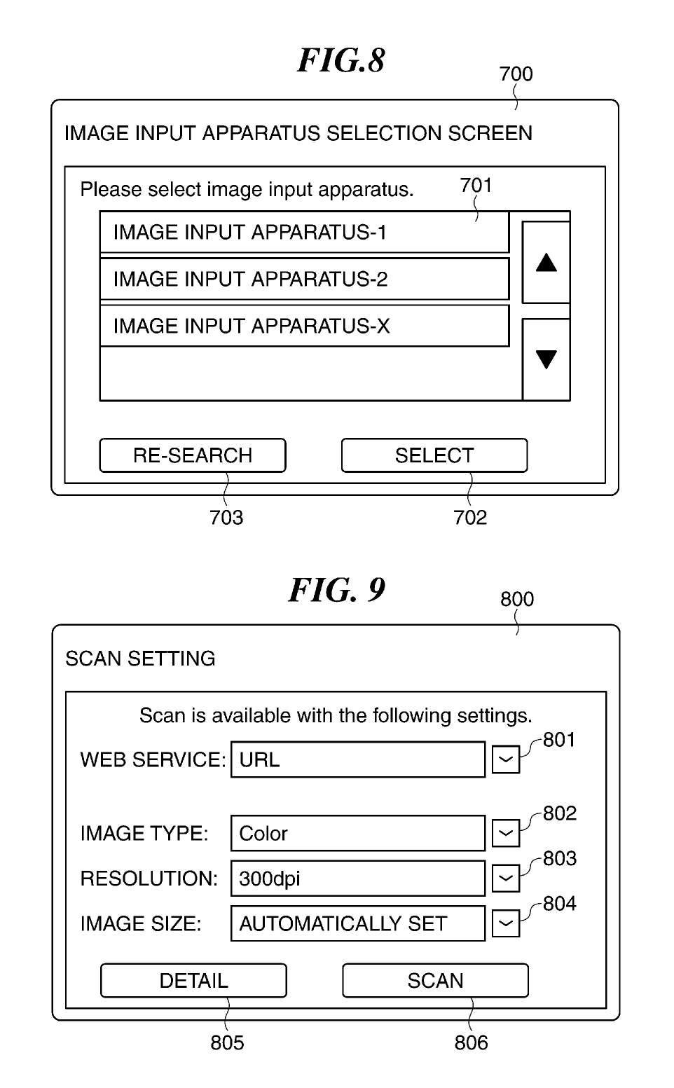

FIG. 8 is a view showing an example of the image input apparatus selection screen. Details of the image input apparatus selection screen shown in FIG. 8 will be described hereinafter. The step S222 corresponds to an operation of a selection screen display unit that acquires a list of retrieved image input apparatuses from a server apparatus, and displays a selection screen for prompting the user to select an image input apparatus to be operated.

The user selects the image input apparatus 102 to be used from the device list (step S223), and the web browser 133 transmits the selection result to the server apparatus 103b, as a device selection message (step S224).

The image input apparatus management program 327 selects a scan script compatible with the selected image input apparatus 102, and the web browser 133 downloads the selected scan script (step S230). The step S230 corresponds to an operation of a setting script-providing unit that provides a setting script for use in configuring settings of an operation of the image input apparatus selected by the information processing apparatus from the provided list, to the image processing apparatus.

The web browser 133 displays a scan setting screen (step S231), and executes the scan script (step S232). FIG. 9 is a view showing an example of the scan setting screen. Details of the scan setting screen shown in FIG. 9 will be described hereinafter.

The user sets an original on the image input apparatus 102 (step S233), and inputs settings for scanning (step S234). Note that although not shown, during execution of the scan script, the information processing apparatus 101 periodically transmits an HTML file update request message to the server apparatus 103b so as to request the same to update the HTML file. By transmitting the update request message, if there is a change in the status of the server apparatus 103b, the information processing apparatus 101 updates the displayed screen according to the update of the HTML file.

The settings set by the user are transmitted to the server apparatus 103b by the scan script as a scan setting message (step S235). The scan job generation program 328 of the server apparatus 103b, first, identifies the URL of the server apparatus as an image storage destination by the setting message received in the step S235. Then, the scan job generation program 328 permits transmission of the image data from the image input apparatus 102 to the URL. At this time, image reception setting is performed by holding a unique authentication ID for authenticating a sender of image data (step S240).

Next, the scan job generation program 328 generates a scan job according to the setting message received in the step S235 (step S241), and transmits the scan job to the information processing apparatus 101 as a scan job message (step S242). The step S242 corresponds to an operation of a setting information-transmitting unit that transmits to the information processing apparatus a job message for causing the image input apparatus to operate according to operation settings set by the information processing apparatus in order to cause the information processing apparatus to transfer the job message to the image input apparatus.

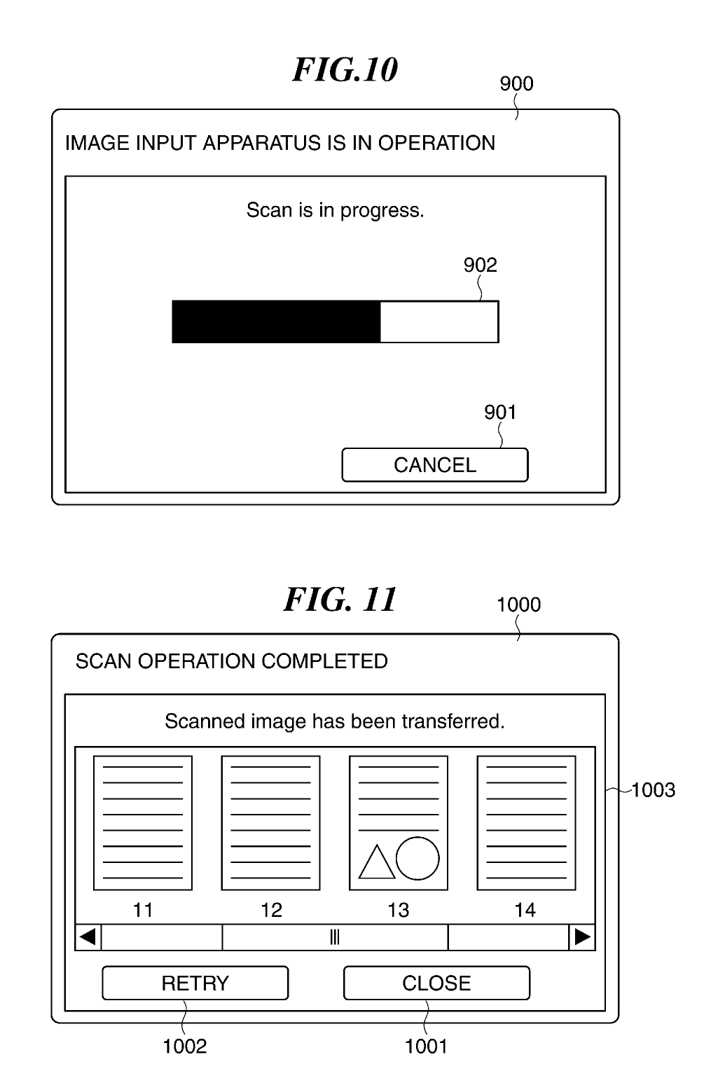

The information processing apparatus 101 having received the scan job message transmits the scan job message to the image input apparatus 102 as a scan job command by the scan script (step S243). This causes the image input apparatus 102 to execute the scan operation (step S244). FIG. 10 is a view showing an example of a scan-in-progress screen which is displayed on the information processing apparatus 101 at this time. Details of the scan-in-progress screen shown in FIG. 10 will be described hereinafter.

The image input apparatus 102 starts the scan operation, and then transmits scanned image data (step S245). The image data varies in type depending on a transmission method used by the image input apparatus 102. In the present example, it is assumed that the scan script executed on the information processing apparatus 101 performs processing similar to that executed by the search script in the step S218. That is, the scan script transmits the image data to the server apparatus 103b by performing processing for IP header conversion of packet data without modifying the contents of the image data (step S246).

Further, similarly to the step S246, the scan script also transmits the image data to the server apparatus 103a (step S249). A destination of image transmission and authentication information used at this time are the URL as the image storage destination in the server apparatus 103a and the user's authentication information, respectively, which are received by the server apparatus 103b from the web browser 133 in the step S202. These are described in the scan job message created in the step S241.

The image reception program 330 of the server apparatus 103b performs appropriate image conversion processing and image storage processing according to the type of image data (step S247). Similarly, the image reception program 330 of the server apparatus 103a performs appropriate image conversion processing and image storage processing according to the type of image data (step S250). The step S250 corresponds to an operation of another storage unit that stores image data input by the operation of the image input apparatus and transferred via the information processing apparatus.

When the image storage processing by the server apparatus 103a is completed, the server apparatus 103a sends a response of a transmission result back to the web browser 133 (step S251). When the image storage processing by the server apparatus 103b is completed, the server apparatus 103b associates the stored image data with the information on the user having accessed the server apparatus 103b (step S248). As an example of the user information used at this time, there may be mentioned a user ID for identifying a user, but this is not limitative in the present invention.

Further, the server apparatus 103b updates the HTML file, and transmits a termination message to the information processing apparatus 101 (step S252).

The scan script executed on the information processing apparatus 101 converts the termination message to a termination command, and transmits the termination command to the image input apparatus 102 (step S253). At this time, the information processing apparatus 101 displays a scan operation completed screen to the user (step S254).

FIG. 11 is a view showing an example of the scan operation completed screen. Details of the scan operation completed screen shown in FIG. 11 will be described hereinafter.

The user goes and picks up the original on which the operation has been completed from the image input apparatus 102 (step S255).

According to the above scan processing sequence, the image data obtained by scanning the original is transferred to the server apparatus 103a and the server apparatus 103b.

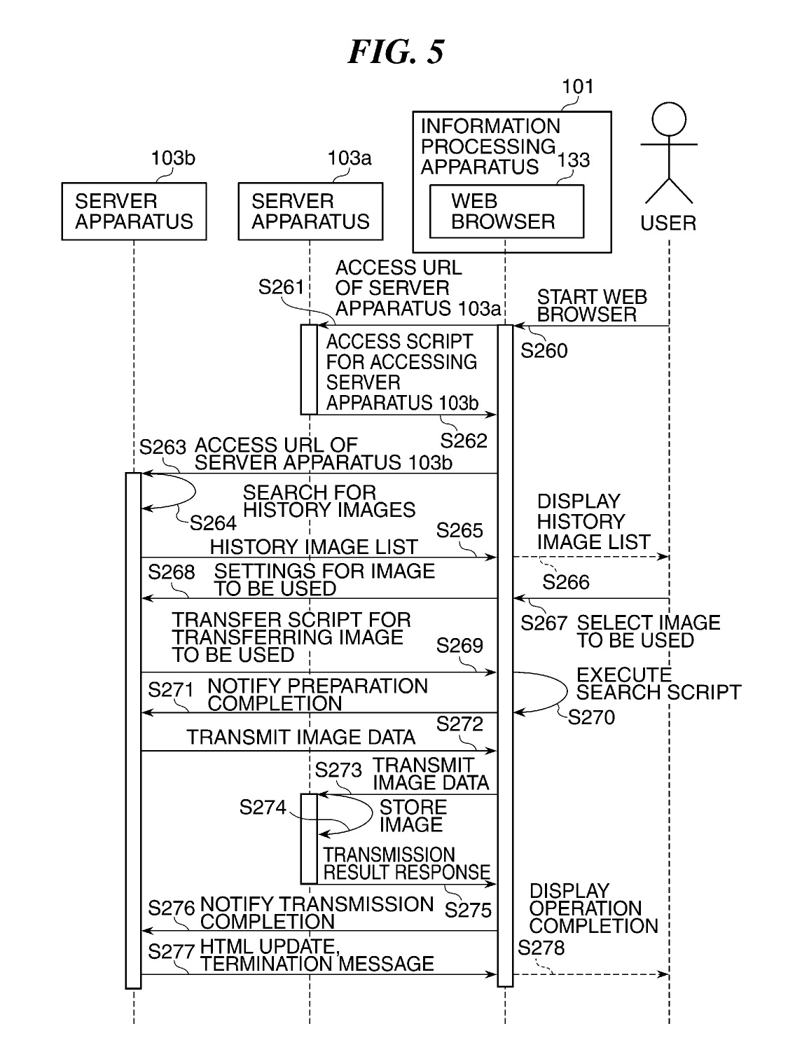

FIG. 5 is a sequence diagram of a scanning process using a history image, which is executed by the server apparatus 103, the information processing apparatus 101, and the image input apparatus 102, appearing in FIG. 1.

The user starts the web browser 133 using the operating section 121 of the information processing apparatus 101 (step S260). Next, the information processing apparatus 101 accesses the URL of the server apparatus 103a (step S261), and logs into the server apparatus 103a to make use of the input service.

When the login is successful, an access script for accessing the server apparatus 103b, the URL as the image storage destination in the server apparatus 103a, and the user's authentication information are downloaded from the server apparatus 103a to the web browser 133 (step S262). The step S262 corresponds to an operation of an access script-providing unit that provides an access script for accessing a second server apparatus which stores image data to be transferred, to the information processing apparatus. Further, the processing performed by the information processing apparatus 101 in the step S262 corresponds to an operation of an access script acquisition unit that acquires an access script for accessing the second server apparatus.

The downloaded script is executed on the web browser 133, and the web browser 133 accesses the server apparatus 103b (step S263).

The server apparatus 103b searches for history images by checking respective user information items associated with the history images stored therein against the information on the user having accessed the server apparatus 103b (step S264). Then, the server apparatus 103b transmits a list of history images found by the search to the web browser 133 (step S265). The step S265 corresponds to an operation of a first list-providing unit that provides a list of stored image data items to the information processing apparatus. Further, the processing performed by the information processing apparatus 101 in the step S265 corresponds to an operation of a list acquisition unit that accesses the second server apparatus using the access script, and acquires the list of image data items stored in the second server apparatus.

The web browser 133 displays the history image list (step S266). In the example illustrated in FIG. 5, the user having viewed the history image list selects an image to be used from the list (step S267). The web browser 133 transmits settings for the history image to be used to the server apparatus 103b according to the user's selection (step S268).

Next, the server apparatus 103b causes the information processing apparatus 101 to download an image transfer script (step S269). The image transfer script is used for performing image data transfer processing similar to the steps S245 to S246 executed by the scan script downloaded in the step S230. Further, the processing performed by the information processing apparatus 101 in the step S269 corresponds to an operation of a transfer script acquisition unit that acquires a transfer script from the second server apparatus for use in acquiring a image data item to be transferred to a first server apparatus, from the image data list, and transferring the acquired image data item.

The information processing apparatus 101 executes the image transfer script (step S270). The information processing apparatus 101 sends a preparation completion notification to the server apparatus 103b after execution of the script (step S271).

The server apparatus 103b transmits the image data to the web browser 133 (step S272). The step S272 corresponds to an operation of an image data-providing unit that is operable when provision of an image data item selected by the information processing apparatus from the list using the transfer script is requested, to provide the image data item to the information processing apparatus.

The image transfer script executed on the information processing apparatus 101 transmits the image data item to the server apparatus 103a by performing processing for IP header conversion of packet data without modifying the contents of the image data item (step S273). The step S273 corresponds to an operation of a transfer unit that acquires an image data item stored in the second server apparatus and transfer the acquired image data to the first server apparatus using the acquired transfer script.

The image reception program 330 of the server apparatus 103a performs appropriate image conversion processing and image storage processing according to the type of the image data item (step S274). The step S274 corresponds to an operation of a storage unit that stores image data transferred from the information processing apparatus through access thereof to the second server apparatus using the access script.

When the image storage processing by the server apparatus 103a is completed, the server apparatus 103a sends a transmission result response to the web browser 133 (step S275).

The information processing apparatus 101 having received the transmission result response sends a transmission completion notification to the server apparatus 103b by the script being executed thereon (step S276). Further, the server apparatus 103b updates the HTML file, and sends a completion message to the information processing apparatus 101 (step S277).

The information processing apparatus 101 displays a scan operation completed screen indicating completion of the operation, shown in FIG. 11, to the user (step S278).

According to the above-described scan processing sequence, a history image data item stored in the server apparatus 103b is transferred to the server apparatus 103a.

Although in the above-described processes according to the sequence diagrams shown in FIGS. 5 and 6, the image data item is transferred only to the server apparatus 103a, this is not limitative, but the image data item can be transferred to one or more server apparatuses by setting the transfer destination to a plurality of server apparatuses. According to the process shown in FIG. 6, the server apparatus 103b, first, provides a list of stored image data items to the information processing apparatus 101. Then, the server apparatus 103b provides the transfer script for transferring image data to one or more server apparatuses 103a to the information processing apparatus 101. When the server apparatus 103b is requested by the information processing apparatus 101 to provide an image data item selected thereby from the provided list using the provided transfer script, the server apparatus 103b provides the requested image data item to the information processing apparatus 101. The provided image data item is transferred to the server apparatus 103a by the information processing apparatus 101. Thus, an image processing system and an information processing apparatus can be provided which reduce the burden on a user in transferring image data to one or more server apparatuses.

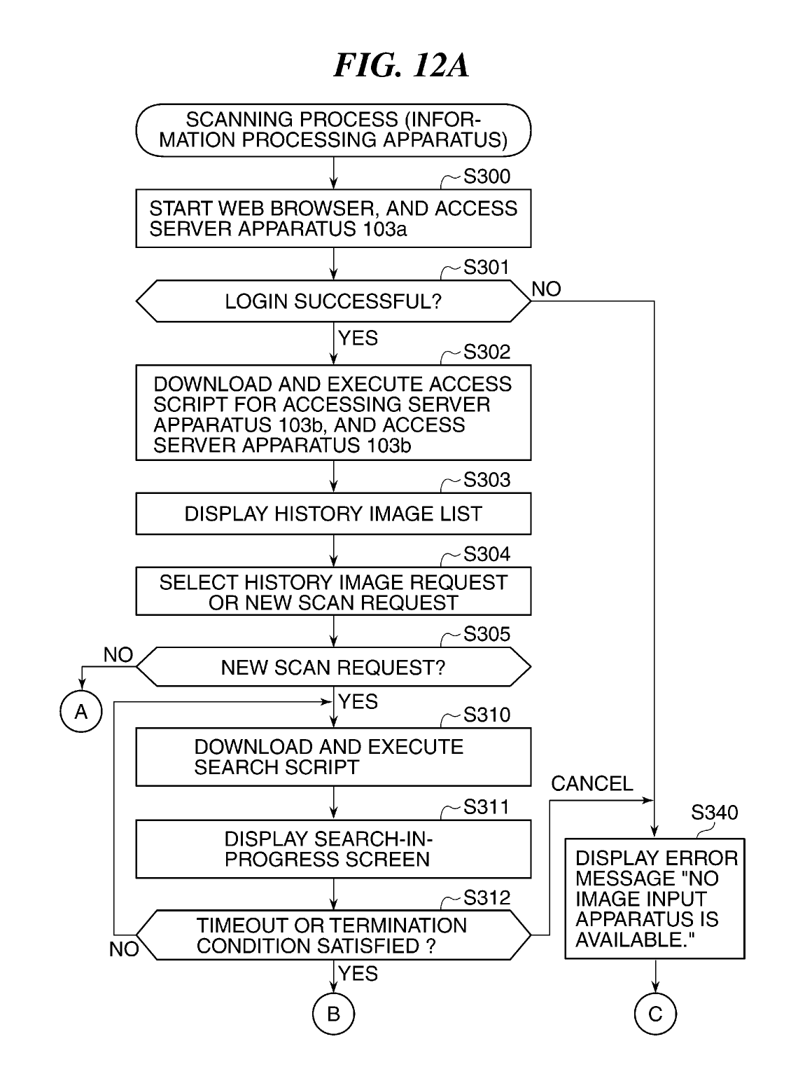

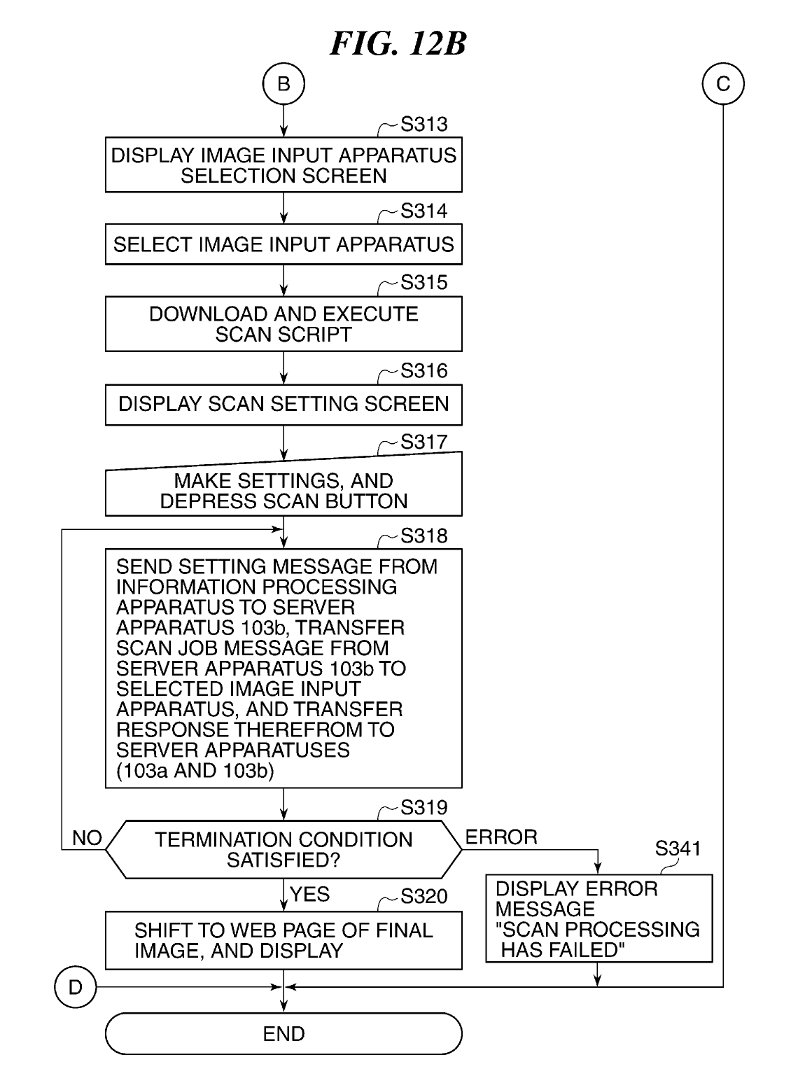

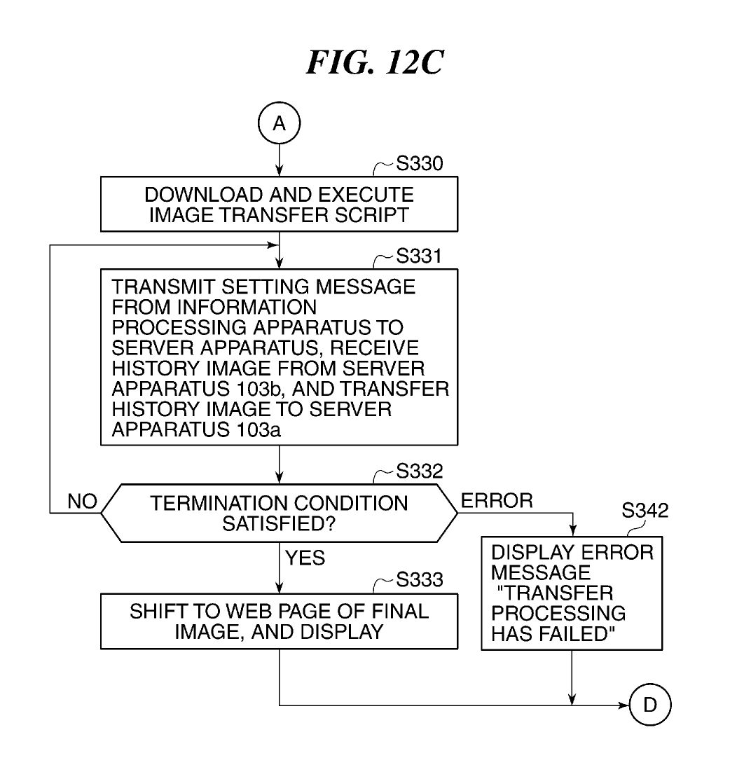

FIGS. 12A to 12C are a flowchart of a scanning process executed by the information processing apparatus 101 appearing in FIG. 1.

In FIGS. 12A to 12C, the information processing apparatus 101 starts the web browser 133 by the OS 131, and accesses the URL of the server apparatus 103a (step S300). The information processing apparatus 101 logs into a web page hosted by the web service library 322 of the server apparatus 103a, and determines whether or not the login is successful (step S301).

If the login is not successful (NO to the step S301), the web browser 133 displays an error message of “No image input apparatus is available.” (step S340), followed by terminating the present process.

If the login is successful (YES to the step S301), the web browser 133 downloads the access script for accessing the server apparatus 103b via the Internet 107, and executes the downloaded access script (step S302). At this time, the URL as an image storage destination in the server apparatus 103a and the user authentication information are simultaneously downloaded to the web browser 133. Further, when the access script is executed, the web browser 133 accesses the URL of the server apparatus 103b, and simultaneously transmits the image storage destination URL and the user authentication information to the server apparatus 103b.

The web browser 133 receives the history image list from the server apparatus 103b as a response to the execution of the access script, and displays an interface for prompting the user to select a history image or a new scan (step S303). Then, a history image or a new scan is selected by the user (step S304).

Then, it is determined whether or not the user has selected a new scan (step S305). If it is determined in the step S305 that the user has selected a new scan (YES to the step S305), the web browser 133 sends a new scan request to the server apparatus 103b. The web browser 133 downloads the search script 326 from the server apparatus 103b via the Internet as a response to the new scan request, and executes the downloaded search script 326 (step S310).

When the search script is executed, a search request message is sent to the server apparatus 103b, and then the search script receives a search protocol-based message as a response to the search request. Then, the search script performs IP header conversion of each network packet of the search protocol-based message to thereby transmit the search protocol-based message to the local network by broadcast.

The search script 326 transfers each of responses sent back from the image input apparatuses 102a and 102b and the like in response to the search protocol-based message sent thereto by broadcast, to the server apparatus 103b as a response message after performing IP header conversion of the network packets of the response. During execution of the above-mentioned search script, the web browser 133 displays the search-in-progress screen shown in FIG. 7, indicating that the image input apparatuses (e.g. 102a and 102b) are being searched for (step S311).

Next, it is determined whether or not session time-out occurs or a termination condition is satisfied (step S312). The “time-out” means that a predetermined time period set for polling processing has expired. Further, the termination condition is that the HTML file is updated by the server apparatus 103b.

If neither session time-out occurs nor satisfaction of the termination condition occurs (NO to the step S312), the process returns to the step S310. At this time, if the processing is canceled by the user, the process proceeds to the step S340.

If session time-out occurs or the termination condition is satisfied (YES to the step S312), the process proceeds to a step S313 in FIG. 12B, wherein the update of the HTML file is performed by the server apparatus 103b, and the web browser 133 displays the image input apparatus selection screen shown in FIG. 8.

When the user selects the image input apparatus to be used on the image input apparatus selection screen (step S314), the server apparatus 103b is notified of a selection result message (step S224). Then, the scan script 329 compatible with the selected image input apparatus is sent from the server apparatus 103b, and is executed by the web browser 133 on the information processing apparatus 101 (step S315).

The executed scan script displays the scan setting screen shown in FIG. 9 (step S316), and prompts the user to depress a scan button 806 to start scan setting and scan processing.

When the scan button 806 is depressed by the user (step S317), the scan script transmits a scan setting message created by the information processing apparatus 101 to the server apparatus 103b. Next, the scan script transfers a scan job message sent from the server apparatus 103b to the image input apparatus 102 selected in the step S306. The scan script transfers a response to the scan job message, which has been sent back from the image input apparatus 102 to the information processing apparatus 101, to the server apparatus 103b (step S318). By repeating the sequence of the above-mentioned processing, the scanned image data included in the responses is transmitted to the server apparatus 103b.

Further, in processing for transferring the responses, which have been sent back from the image input apparatus 102 to the information processing apparatus 101, to the server apparatus 103b, the same image data is simultaneously transmitted to the server apparatus 103a.

The server apparatuses 103a and 103b determine whether or not the image storage processing (steps S248 and S249) by the server apparatuses 103a and 103b is completed, or a predetermined time period set for image data reception has timed out, respectively.

At this time, the information processing apparatus 101 having received a result of the determination by the server apparatus 103a transmits the received result of the determination to the server apparatus 103b, and the server apparatus 103b performs the above-mentioned determination not only based on the processing of its own but also based on the received result of the determination by the server apparatus 103a. The result of the determination by the server apparatus 103b is received by the web browser 133 as the HTML file update.

Next, it is determined whether or not the termination condition is satisfied (step S319). If the termination condition is satisfied (YES to the step S319), the process proceeds to a step S320. Note that the termination condition in this step is that the image storage processing by the server apparatuses 103 for receiving the responses is completed. If an error, such as a time-out error, occurs in the above-mentioned sequence of processing, an HTML file indicative of an error message of “Scan processing has failed.” is received from the server apparatus 103b and displayed (step S341), followed by terminating the present process.

If the termination condition is satisfied (YES to the step S319), the scan operation completed screen shown in FIG. 11 is displayed by shifting to a web page of the final image (step S320), followed by terminating the present process.

If it is determined in the step S305 that a new scan has not been selected by the user (NO to the step S305), i.e. a history image is to be used, the process proceeds to a step S330 et seq. in FIG. 12C to perform the following processing: The web browser 133 sends a history image request, downloads the image transfer script 331 from the server apparatus 103b via the Internet as a response to the history image request, and executes the downloaded image transfer script 331 (step S330).

When the image transfer script is executed, the information processing apparatus 101 sends, to the server apparatus 103b, a transmission request requesting the server apparatus 103b to transmit a history image. The information processing apparatus 101 receives the history image from the server apparatus 103b as a response to the transmission request, and transfers the received history image to the server apparatus 103a. By repeating a sequence of the above-mentioned processing, the image data is transmitted to the server apparatus 103b (step S331).

Next, it is determined whether or not the termination condition is satisfied (step S332). The termination condition in this step is that the image storage processing (step S274 in FIG. 5) has been completed. If it is determined in the step S332 that the termination condition is not satisfied (NO to the step S332), the process returns to the step S331. If the termination condition is satisfied (YES to the step S332), the scan operation completed screen shown in FIG. 11 is displayed by shifting to the web page of the final image, followed by terminating the present process. Further, in the step S332, if a cancellation occurs (ERROR to the step S332), an HTML file indicative of an error message of “Transfer processing has failed.” is received from the server apparatus 103b (step S277 in FIG. 5) and is displayed (step S342), followed by terminating the present process.

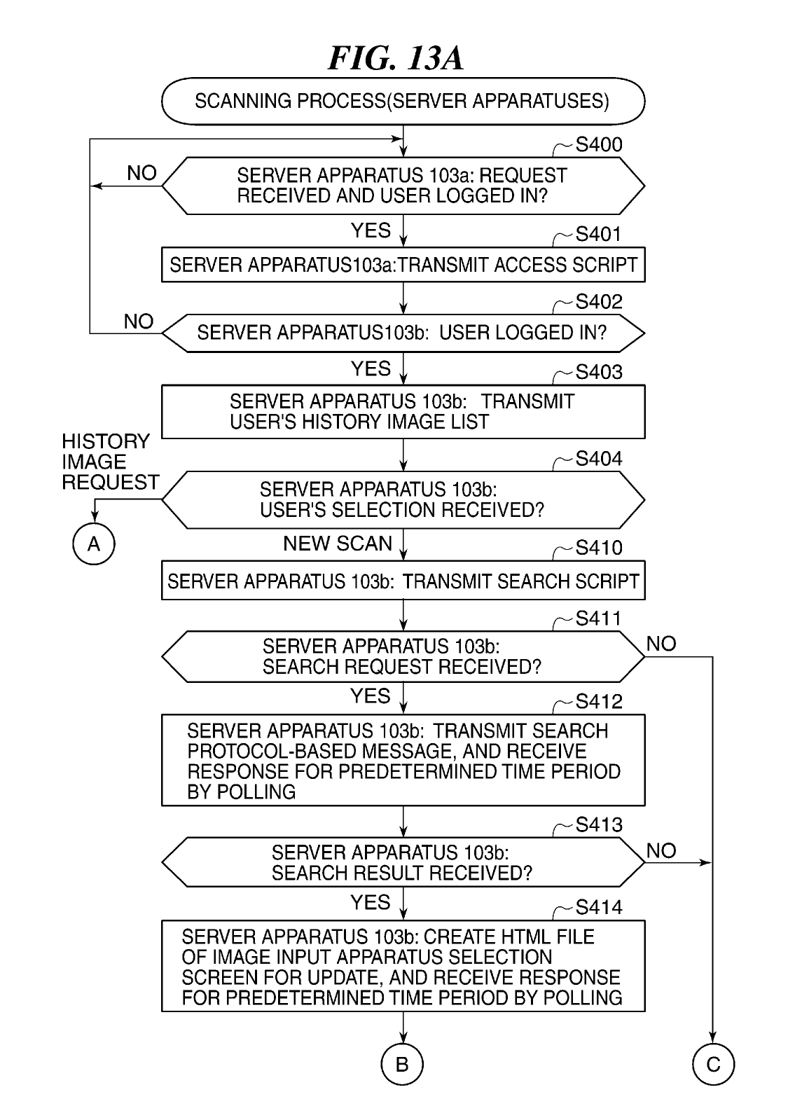

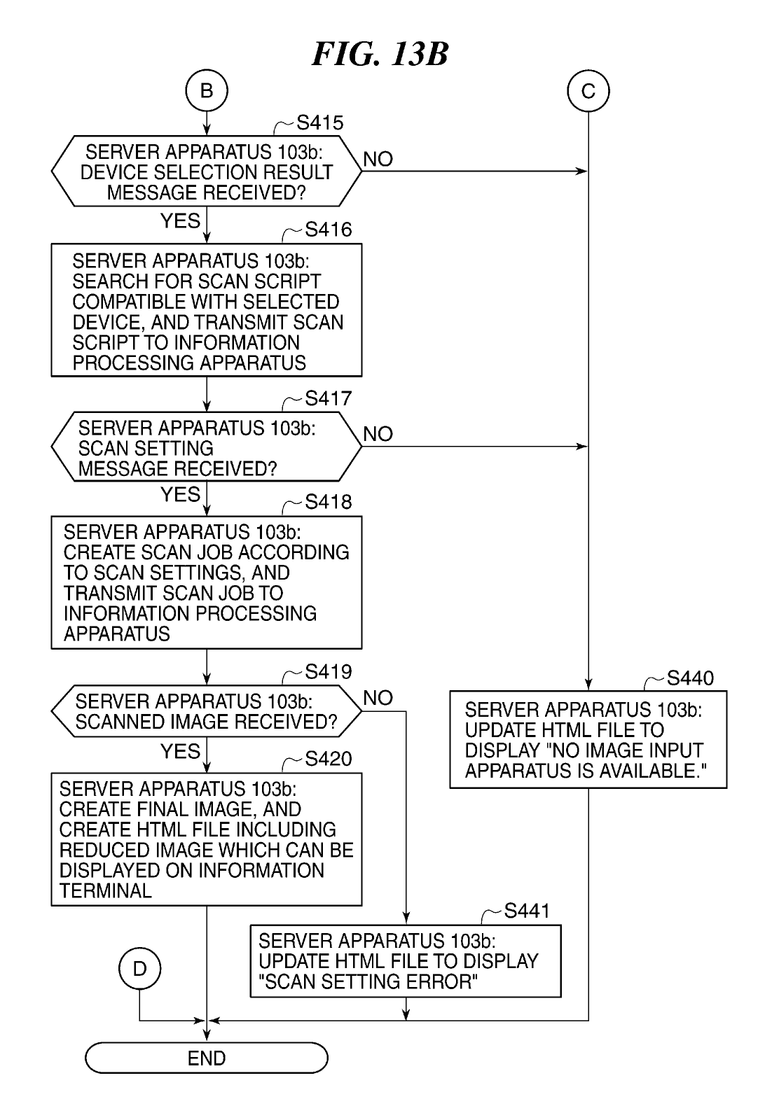

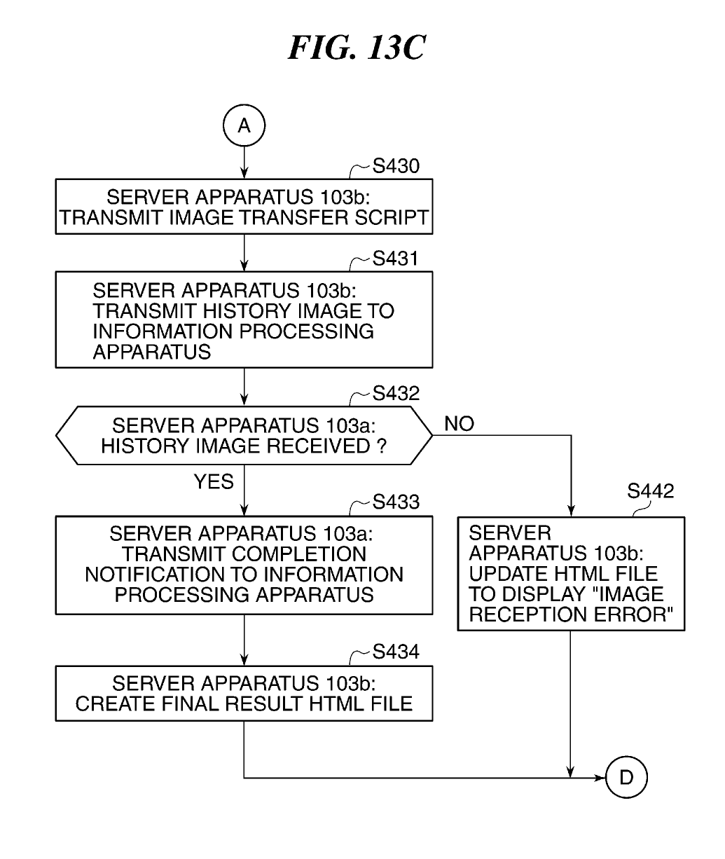

FIGS. 13A to 13C are a flowchart of a scanning process executed by the server apparatuses 103a and 103b, appearing in FIG. 1.

The server apparatus 103a receives a request message from the information processing apparatus 101, and then, when the user logs into the server apparatus 103a (YES to a step S400), the server apparatus 103a prompts the user to download the access program 324 for accessing the server apparatus 103b, user information, and an image storage destination URL in the server apparatus 103a (step S401). If the login is not successful (NO to the step S400), the step S400 is executed again.

When the access script is executed by the web browser 133 on the information processing apparatus 101, the web browser 133 logs into the server apparatus 103b (YES to a step S402), and the server apparatus 103b searches for history images associated with the user information. If the login is not successful (NO to the step S402), the step S400 is executed again.

The server apparatus 103b creates a list of history images found by the search as an HTML file, and transmits the history image list to the information processing apparatus 101 (step S403). Then, the server apparatus 103b determines what has been selected by the user based a result of a selection made by the user and transmitted from the information processing apparatus to the server apparatus 103b (step S404).

If it is determined in the step S404 that a new scan has been selected (new scan in the step S404), the server apparatus 103b having received a new scan request from the information processing apparatus 101 transmits the search script 326 to the information processing apparatus 101 (step S410).

When the search script is executed by the web browser 133 on the information processing apparatus 101, a search request message is transmitted. The server apparatus 103b determines whether or not a search request by the search request message has been received from the information processing apparatus 101 (step S411).

If it is determined in the step S411 that no search request has been received (NO to the step S411), the process proceeds to a step S440 in FIG. 13B, wherein the server apparatus 103b creates an HTML file for displaying a message of “No image input apparatus is available.”, and causes the web browser 133 to display the message, followed by terminating the present process. This is performed by making use of the search script performing periodical transmission of the HTML file update request message to the server apparatus 103b.

If it is determined in the step S411 that a search request has been received (YES to the step S411), the search program 325 sends a search protocol-based message to the information processing apparatus 101 (step S214 in FIG. 4A), and continues polling processing for receiving responses for a predetermined time period (step S412). These responses are analyzed by the search program 325.

When the predetermined time period has elapsed, the search program 325 determines whether or not a search result has been received (step S413).

If it is determined in the step S413 that no search result has been received (NO to the step S413), the following processing is performed: The search program 325 updates the HTML file to one for displaying a message “No image input apparatus is available.”, and causes the web browser 133 to display the message (step S440), followed by terminating the present process. The message of “No image input apparatus is available.” means that an environment for scan processing cannot be created.

If it is determined in the step S413 that the search program 325 has received a search result (YES to the step S413), the following processing is performed: The image input apparatus management program 327 is started to create an image input apparatus selection screen HTML file. Then, the image input apparatus management program 327 causes the web browser 133 to display the image input apparatus selection screen, and waits and receives a response from the user via the updated selection screen for a predetermined time period (step S414).

Then, the image input apparatus management program 327 proceeds to a step S415 in FIG. 13B to determine whether or not a device selection result message (step S224) has been received (step S415). The step S415 is executed after the predetermined time period has elapsed.

If it is determined in the step S415 that no device selection result message has been received (NO to the step S415) e.g. for a reason that there is no input from the user to the information processing apparatus 101, the process proceeds to the step S440.

If it is determined in the step S415 that a device selection result message has been received (YES to the step S415), the image input apparatus management program 327 searches for a scan script 329 compatible with the selected apparatus. Then, the image input apparatus management program 327 sends the scan script 329 found by the search to the web browser 133 of the information processing apparatus 101 (step S416).

Next, the image input apparatus management program 327 determines whether or not a scan setting message (step S235) has been received (step S417). If it is determined in the step S417 that no scan setting message has been received (NO to the step S417), the process proceeds to the step S440.

If it is determined in the step S417 that a scan setting message has been received (YES to the step S417), the scan job generation program 328 is started. Then, the scan job generation program 328 generates a scan job according to the received scan setting message (step S235), and transmits the generated scan job to the web browser 133 of the information processing apparatus 101 (step S418).

Next, the server apparatus 103b starts the image reception program 330 to determine whether or not a scanned image has been received (step S419).

If it is determined in the step S419 that no scanned image has been received (NO to the step S419), the following processing is performed: The image reception program 330 creates an HTML file for displaying a message of “scan setting error”, and causes the web browser 133 to display the message (step S441), followed by terminating the present process. This is executed by making use of the search script performing periodical transmission of the HTML file update request message to the server apparatus 103b. Further, the message of “scan setting error” means that an environment for scan processing cannot be created.

If it is determined in the step S419 that a scanned image has been received (YES to the step S419), the image reception program 330 creates a final scan image from the received image data (step S246). Then, the image reception program 330 creates an HTML file including a reduced image which can be displayed on the information processing apparatus 101 (step S420). Then, by transmitting the HTML file to the information processing apparatus 101, the scan operation completed screen shown in FIG. 11 is displayed.

Referring again to FIG. 13A, if it is determined in the step S404 that a history image is selected (history image request in the step S404), the process proceeds to a step S430 et seq. in FIG. 13C to perform the following processing: The server apparatus 103b having received the history image request from the information processing apparatus 101 in the step S404 transmits the image transfer script 331 to the information processing apparatus 101 (step S430).

When the image transfer script 331 is executed by the web browser 133 on the information processing apparatus 101, a history image is requested, and hence the server apparatus 103b transmits the requested history image to the information processing apparatus 101 (step S431).

The server apparatus 103a determines whether or not the history image transferred from the information processing apparatus 101 has been received (step S432). If it is determined in the step S432 that the server apparatus 103a has received the history image (YES to the step S432), the image reception program 330 creates a final history image from the image data (step S273). Then, the server apparatus 103a transmits a completion notification to the information processing apparatus 101 as a response (step S433).

If it is determined in the step S432 that the server apparatus 103a has received no history image (NO to the step S432), the server apparatus 103a notifies the information processing apparatus 101 of an error. Then, the information processing apparatus 101 transfers the error notification to the server apparatus 103b. The server apparatus 103b having received the error notification updates the HTML file to one for displaying a massage of “image reception error” to the effect that an image cannot be received, and causes the web browser 133 to display the message (step S422). Note that when a predetermined time period set for image data reception has timed out during reception of the history image as well, it is determined that the server apparatus 103a has received no history image.

If it is determined in the step S432 that the server apparatus 103a has received a history image (YES to the step S432), the image reception program 330 creates a final history image from the image data (step S273). Then, the server apparatus 103a transmits a completion notification to the information processing apparatus 101 as a response (step S433).

The information processing apparatus 101 transfers the completion notification sent from the server apparatus 103a to the server apparatus 103b. The server apparatus 103b having received the transferred completion notification creates a final result HTML file for display on the information processing apparatus 101 (step S434). By transmitting the HTML file to the information processing apparatus 101, the scan operation completed screen shown in FIG. 11 is displayed on the information processing apparatus 101.

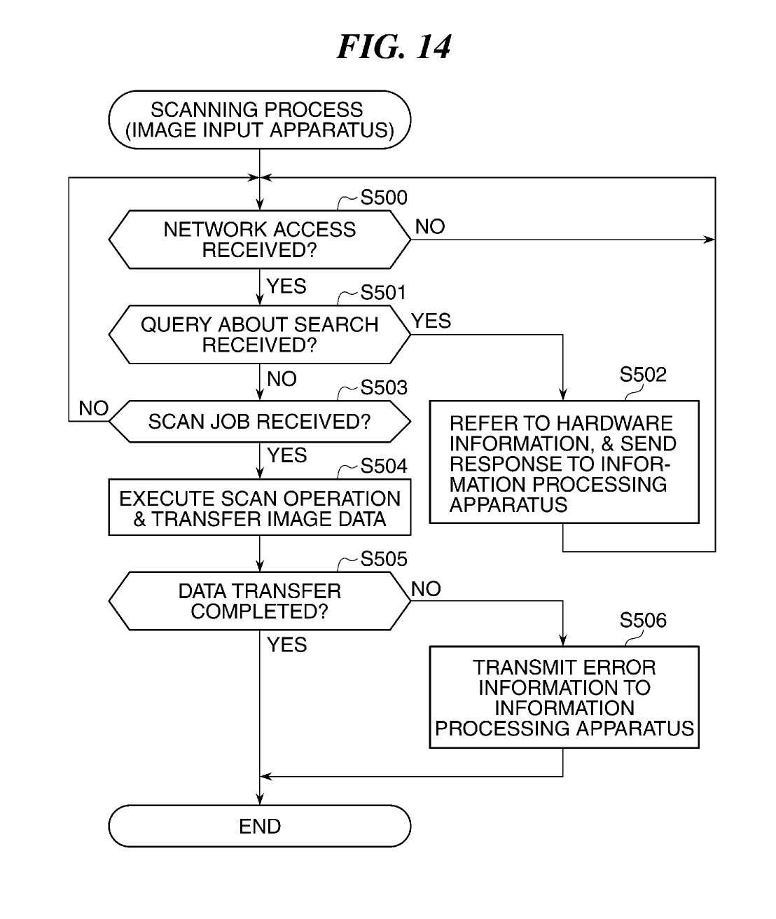

FIG. 14 is a flowchart of a scanning process executed by the image input apparatus 102 appearing in FIG. 1.

In FIG. 14, the image input apparatus 102 waits for access to the network interface 205 from the outside via the local network 104. When the image input apparatus 102 receives a network access in this state (YES to a step S500), the image input apparatus 102 is activated (returns from the sleep state), and it is determined whether or not a query about the search by a search command is received (step S501).

If it is determined in the step S501 that a query about the search has been received (YES to the step S501), the image input apparatus 102 refers to the hardware information 221 stored in the external memory 220. Then, the image input apparatus 102 sends a response to the information processing apparatus 101 (step S502), and the process returns to the step S500.

On the other hand, if it is determined in the step S501 that no query about the search has been received (NO to the step S501), it is determined whether or not a scan job has been received from the information processing apparatus 101 (step S503). If it is determined in the step S503 that no scan job has been received (NO to the step S503), the process returns to the step S500.

On the other hand, if it is determined in the step S503 that a scan job has been received (YES to the step S503), the image input apparatus 102 performs the scan operation and the image data transfer to the information processing apparatus 101 (step S504).

Then, it is determined whether or not the data transfer is completed (step S505). This determination is performed by determining whether or not a termination command has been received from the information processing apparatus 101 within a predetermined time period.

If it is determined in the step S505 that a termination command has been received (YES to the step S505), the present process is terminated. On the other hand, if it is determined in the step S505 that no termination command has been received (NO to the step S505), the image input apparatus 102 transmits error information to the information processing apparatus 101 (step S506), followed by terminating the present process.

The screens in FIGS. 6 to 11 referred to in the above description will be described in detail.

The input image selection screen, denoted by reference numeral 500 in FIG. 6, is displayed by the web browser 133 in the following manner: First, in the step S303 in FIG. 12A, the server apparatus 103b creates an HTML file including a reduced image which can be displayed on the information processing apparatus 101. Then, the HTML file is transmitted to the web browser 133 on the information processing apparatus 101, whereby the input image selection screen 500 is displayed on the web browser 133.

A reduced image-displaying area 503 is displayed on the input image selection screen 500 to inform the user of the contents of history images.

When the user selects an image, and depresses a determination button 501, the process proceeds to the step S330 in FIG. 12C. On the other hand, when the user depresses a new scan button 502, the process proceeds to the step S310 in FIG. 12A.

The search-in-progress screen, denoted by reference numeral 600 in FIG. 7 is a screen displaying the HTML file which has been updated by the server apparatus 103 in a state in which the search script is being executed. If a cancel button 601 is depressed by the user, the search script sends a cancel message to the server apparatus 103, whereby the search process is aborted.

The image input device selection screen, denoted by reference numeral 700 in FIG. 8, is a screen which the web browser 133 displays based on the HTML file updated by the image input apparatus management program 327 of the server apparatus 103b in the step S313 in FIG. 12B (image input device selection screen HTML file).

In an image input apparatus list display section 701, when the user depresses a selection button 702, the search script sends a selection result message to the server apparatus 103b. The server apparatus 103b prepares the scan script 329 compatible with the selected image input apparatus 102.

When the user depresses a re-search button 703, a search request is sent to the server apparatus 103b as a message again, and the steps S212 to S220 in FIG. 4A are executed again. As a result, the contents of the image input apparatus list display section 701 are updated.

The scan setting screen, denoted by reference numeral 800 in FIG. 9, is a screen for enabling the user to select settings of the scan processing.

On the scan setting screen 800, there are displayed a web service selection drop-down combo box 801 for selecting a web service, and an image type drop-down combo box 802, a resolution drop-down combo box 803, and an image size drop-down combo box 804, which are for configuring settings of the scanning operation. Also displayed on the scan setting screen 800 are a detail button 805 and the scan button 806.

When the user depresses the scan button 306, the scan script 329 transmits the settings configured from the buttons 801 to 804 at the time to the server apparatus 103 as a setting message (step S235 in FIG. 4B).

The detail button 805 is a button which is depressed by the user, for making more detailed settings. Although not shown in detail, when the detail button 805 is depressed, the scan script 329 updates the HTML file of the “scan setting” screen, whereby the user is prompted to make additional settings. When the additional settings are made, and a button, not shown, for storing the settings is depressed, the display returns to the scan setting screen 800.

The scan-in-progress screen, denoted by reference numeral 900 in FIG. 10, will be described. The scan-in-progress screen is a screen displayed after the scan button 806 is depressed on the scan setting screen 800 shown in FIG. 9. As shown in FIG. 10, the status is also displayed by a scan processing progress indicator 902.

The scan processing progress indicator 902 is displayed by the scan script 329 downloaded and executed on the web browser 133 when after starting the scan operation by the image input apparatus 102, the scanning process has reached the step S244 in FIG. 4B.

A cancel button 901 is used by the user for depressing the same to cancel the scan processing being executed. When the cancel button 901 is depressed, the scan script transmits a cancel message to the server apparatus 103b.

The server apparatus 103 transmits a scan job message including the cancellation to the information processing apparatus 101 similarly to the step S242 in FIG. 4B, whereby a sequence of cancel job commands are transmitted to the image input apparatus 102 similarly to the step S243 in FIG. 4B. The scan script updates the scan-in-progress screen 900 while transmitting image data in the steps S246 and S247, whereby the scan processing progress indicator 902 displays the status of image data transmission to the user.

The scan operation completed screen, denoted by reference numeral 1000 in FIG. 11, will be described. When image data reception is completed in the image storage processing, the image reception program 330 creates an HTML file including reduced images which can be displayed on the information processing apparatus 101 from the image data.

Then, the HTML file is transmitted to the web browser 133, whereby the scan operation completed screen 1000 is displayed to notify the user of the operation completion.

A reduced image display area 1003 is displayed on the scan operation completed screen 1000 to notify the user of the contents of the final scanned image. When the user depresses a close button 1001, the scan operation completed screen 1000 is closed, whereby the scan script 329 downloaded and executed by the web browser 133 is terminated. When the user depresses a retry button 1002, the process returns to the step S230, wherein the scan setting screen 800 shown in FIG. 9 is displayed.

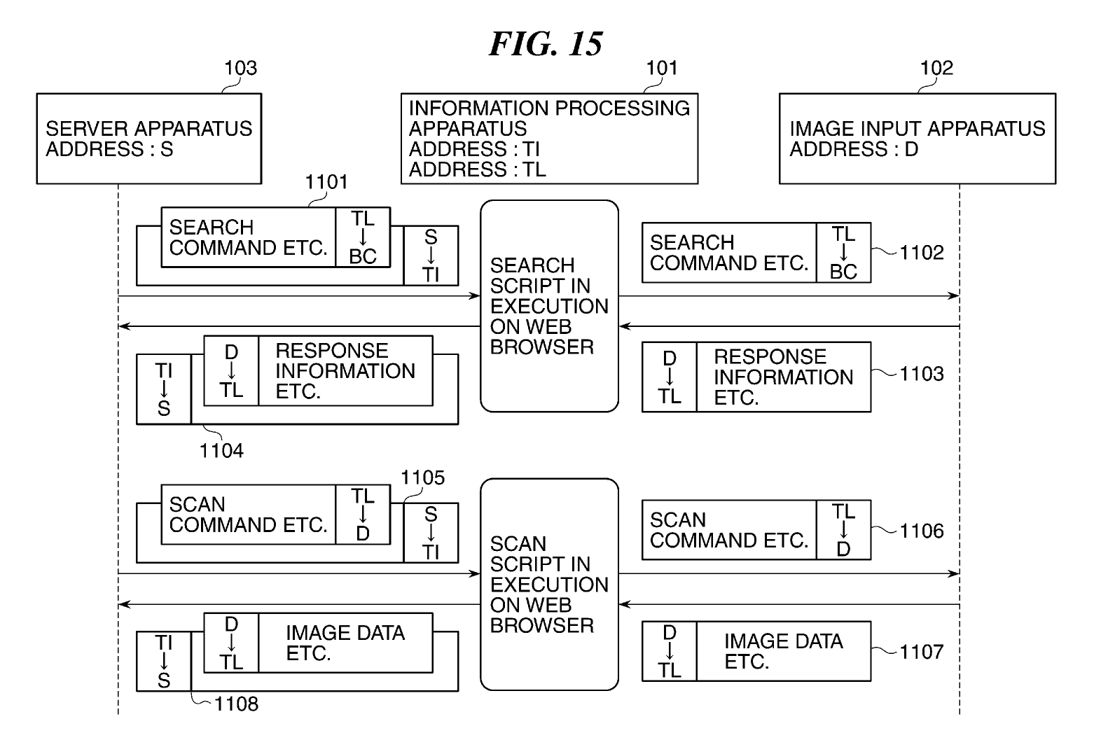

FIG. 15 is a diagram showing an example of the contents of data which are transmitted and received, and processing of data transmission and reception performed by the search script 326 and the scan script 329 when the search script 326 and the scan script 329 of the server apparatus 103b are executed by the web browser 133 of the information processing apparatus 101.

In FIG. 15, first, a description will be given of a network address. An address of the server apparatus 103 connected to the Internet 107 via the network interface 307 is represented by S. A network address of the information processing apparatus 101 in the network 106 for connecting to the server apparatus via the Internet 107 connected via the first communication interface 114 is represented by TI. A network address of the information processing apparatus 101 used when the second communication interface 119 is connected to the local network 104 is represented by TL. A network address of the image input apparatus 102 used when the image input apparatus 102 is connected to the local network 104 via the network interface 205 is represented by D.

Next, a description will be given of a representative example of data transmitted and received by the scripts. Data 1101 is an example of data transmitted as a search protocol-based message from the server apparatus 103b to the search script being executed by the web browser 133 of the information processing apparatus 101 in the step S214 in FIG. 4A.

The server apparatus 103b creates the data 1101 such that it has a structure in which information for transmitting the data 1101 to the local network 104 is included in the header of packet data which contains a search command or the like as the payload. To transmit the entire data from the server apparatus 103b to the information processing apparatus 101, the data is created such that the header of the data defines transmission from the network address S to the network address TI.

The search script of the information processing apparatus 101 which has received the packet data including the data 1101 takes out only contained packet data, and transfers the packet data to the local network 104 as data 1102. As shown in FIG. 15, the packet data in this case is addressed to BC. It is assumed that the destination BC indicates broadcast transmission. Through the taking out of packet data executed by the search script, as described above, the broadcasting of the search protocol-based message in the step S215 in FIG. 4A is realized.

Data 1103 is an example of packet data sent by the image input apparatus 102 as a response to the search command. The data 1103 has a header for transmission thereof from the network address D of the image input apparatus 102 to the network address TL of the information processing apparatus 101 on the local network 104. Further, the payload contains response information including the hardware information 221.

The search script having received the packet data of the data 1103 generates packet data containing the data 1103. The search script transfers the generated data as data 1104 from the network address TI to the network address S of the server apparatus 103b. The network address TI is the address of the information processing apparatus 101 on the network 106 connected to the server apparatus 103b via the Internet 107.

By transmitting the data having the above-mentioned packet data structure to the server apparatus 103b, the server apparatus 103b can acquire the network address TL of the information processing apparatus 101 on the network 104. Similarly, the server apparatus 103b can acquire the network address D of the image input apparatus 102 having sent the response to the search command.

Data 1105 is an example of a scan script in the step S242 in FIG. 4B. The data 1105 has the same packet data structure as the data 1101. More specifically, the data 1105 is created such that the header of packet data, which contains e.g. a scan command as the payload, includes information for transmission to the local network 104. To transmit the entire data from the server apparatus 103b to the information processing apparatus 101, the data is created such that the header thereof defines transmission from the network address S to the network address TI.

The scan script having received the packet data of the data 1105 takes out only contained packet data, and transfers the taken-out packet data to the local network 104 as data 1106.

The server apparatus 103b has already acquired, from the data 1104, the network address TL of the information processing apparatus 101 on the local network 104 and the network address D of the image input apparatus 102 having sent the response to the search command. The data 1105 is created using these addresses, and hence the scan script can easily create data which can be transmitted to the local network 104 only by routinely taking out the contained packet data.

Data 1107 is an example of packet data transmitted by the image input apparatus 102 as image data generated as a result of the scan operation. The data 1107 has a header for transmission from the network address D of the image input apparatus 102 to the network address TL of the information processing apparatus 101 on the local network 104. Further, the data 1107 contains image data information and the like in the payload.

The scan script having received the packet data of the data 1107 generates packet data containing the data 1107. The scan script transfers the generated packet data from the network address TI to the server apparatus 103b as data 1108.

Note that the data 1107 is generated as each of divisional data items obtained by dividing the whole image data according to designation of the scan command. Further, the scan script sequentially processes the packets which correspond to the divisional data items of the data 1107 and are sent in a plurality of respective times. By transmitting each data to the server apparatus 103b with a data structure indicated by the data 1108, it is possible to process the packet data even when the capacity of the RAM 112 of the information processing apparatus 101 used by the scan script is small.

Although not described in detail here, when the control of a network port is required, switching of the network port is described in a destination part of packet data together with a network address. This enables each script to cope with control of the network port by performing packet data generation including the conversion of the destination part.

Further, the search script and the scan script in the present embodiment can execute other functions. The scan script displays the scan setting screen 800 shown in FIG. 9, and transmits information set by the user to the server apparatus 103b as a message.

The search script and the scan script periodically check the status of the server apparatus 103b to thereby periodically check the server apparatus 103b as to whether or not update of the display contents is necessary. The server apparatus 103b sends a notification e.g. of error handling in the server apparatus 103b to the information processing apparatus 101 as a message, whereby the search script and the scan script can operate according to the message.

In the above-described embodiment, communication between the server apparatus and the image input apparatus via the information processing apparatus may be performed by any method insofar as it can be executed by the information processing apparatus. More specifically, communication may be performed using the ActiveX control, the Java (registered trademark) script, the Java (registered trademark) applet, or any of various types of plug-ins. However, it is efficient to perform preparations to be executed in the information processing apparatus in order of priority, because the server apparatus has choices of a plurality of execution methods, and is not required to have a function of a device which is most frequently used.

Further, to easily and efficiently perform bi-directional communication, it is also effective to use a bi-directional communication technique, such as Websockets http://dev.W3.Org/html5/WebSockets. When the technique e.g. of WebSockets is introduced, it is unnecessary to perform such processing as described above in which a script periodically sends an HTML file update request message to the server apparatus 103. Further, it is possible to update a message sent from the server apparatus 103 without a request from the information processing apparatus 101.

Further, it is also possible to realize the communication e.g. by using WS-Eventing or GENA (general event notification architecture) as a protocol for sending a notification.

Further, the search script operating on the information processing apparatus 101 can be operated using any suitable protocol insofar as the protocol is capable of properly notifying the search script of hardware information and makes it possible to obtain the same result. Therefore, the present invention is not limited to the above-described embodiment.

Further, as a method of performing a scan operation in an image input apparatus, the above-described embodiment employs a method of generating a scan job and transmitting the generated scan job to the image input apparatus. However, if it is possible to transmit general information, such as a scan job ticket, to an image input apparatus, it is also possible to perform the scan processing by employing this method.

Further, as a method of transferring a history image, the above-described embodiment employs a method of transmitting a history image from the server apparatus 103b to the server apparatus 103a via the user's information processing apparatus 101.

However, for example, when the server apparatus 103a and the server apparatus 103b are in a trust relationship, it is also possible to operate the system by employing a method of directly transmitting a history image from the server apparatus 103b to the server apparatus 103a. Therefore, the transfer method in the present invention is not limited to that described in the embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-123643, filed Jun. 1, 2011, which is hereby incorporated by reference herein in its entirety.

What is claimed is:

1. An image processing system including a first server apparatus which stores image data transferred via an information processing apparatus, and a second server apparatus which stores image data to be transferred to the first server apparatus,
wherein the first server apparatus comprises:
an access script-providing unit configured to provide an access script to the information processing apparatus, for use in accessing the second server apparatus; and
a storage unit configured to store image data transferred from the information processing apparatus,
wherein the second server apparatus comprises:
a first list-providing unit configured to provide a list of stored image data items to the information processing apparatus; and
an image data-providing unit configured to be operable when requested to provide an image data item selected from the list provided by said first list-providing unit, to provide the requested image data item to the information processing apparatus, and
wherein the information processing apparatus comprises:
an access unit configured to access the second server apparatus according to the access script provided by said access script-providing unit;
a selection unit configured to select an image data item from the list of image data items provided by said first list-providing unit, and
a transfer unit configured to transfer the image data item provided by said image data-providing unit to the first server apparatus.

2. The image processing system according to claim 1, further comprising image input apparatuses to each of which image data to be transferred to at least the first server apparatus is input, and
wherein the second server apparatus further comprises:
a second list-providing unit configured to provide a list of image input apparatuses found by a search made from the information processing apparatus, to the information processing apparatus;
a setting script-providing unit configured to provide a setting script to the information processing apparatus, for use in configuring settings of an operation of an image input apparatus selected at the information processing apparatus from the list provided by said second list-providing unit; and
a setting information-transmitting unit configured to transmit a job message to the information processing apparatus, so as to cause the information processing apparatus to transfer the job message to the image input apparatus for causing the image input apparatus to operate according to the settings of the operation configured by the information processing apparatus using the setting script provided by said setting script-providing unit, and
wherein the second server apparatus further comprises:
another storage unit configured to store image data input to the image input apparatus, and transferred from the image input apparatus via the information processing apparatus.

3. An information processing apparatus that receives image data from a second server apparatus storing image data to be transferred to a first server apparatus storing image data, and transfers the received image data to the first server apparatus, comprising:
an access script acquisition unit configured to acquire, from the first server apparatus, an access script for accessing the second server apparatus;
a list acquisition unit configured to access the second server apparatus using the access script acquired by said access script acquisition unit, and acquire a list of image data items stored in the second server apparatus;
a transfer script acquisition unit configured to acquire, from the second server apparatus, a transfer script for use in acquiring an image data item to be transferred to the first server apparatus from the list of image data items acquired by said list acquisition unit to thereby transfer the acquired image data item; and
a transfer unit configured to acquire the image data item stored in the second server apparatus and transfer the acquired image data item to the first server apparatus, using the transfer script acquired by said transfer script acquisition unit.

4. The information processing apparatus according to claim 3, further comprising a search unit configured to search for image input apparatuses when image data stored in the second server apparatus is not used.

5. The information processing apparatus according to claim 4, further comprising a selection screen display unit configured to acquire a list of image input apparatuses found by a search by said search unit from the second server apparatus, and display a selection screen for prompting a user to select an image input apparatus to be operated, from the list.

6. A method of controlling an information processing apparatus that receives image data from a second server apparatus storing image data to be transferred to a first server apparatus storing image data, and transfers the received image data to the first server apparatus, comprising:
acquiring, from the first server apparatus, an access script for accessing the second server apparatus;
accessing the second server apparatus using the acquired access script, and acquiring a list of image data items stored in the second server apparatus;
acquiring, from the second server apparatus, a transfer script for use in acquiring an image data item to be transferred to the first server apparatus from the acquired list of image data items to thereby transfer the acquired image data item; and
acquiring the image data item stored in the second server apparatus and transferring the acquired image data item to the first server apparatus, using the acquired transfer script.

7. A non-transitory computer-readable storage medium storing a computer-executable program for executing a method of controlling an information processing apparatus that receives image data from a second server apparatus storing image data to be transferred to a first server apparatus storing image data, and transfers the received image data to the first server apparatus,
wherein the method comprises:
acquiring, from the first server apparatus, an access script for accessing the second server apparatus;
accessing the second server apparatus using the acquired access script, and acquiring a list of image data items stored in the second server apparatus;
acquiring, from the second server apparatus, a transfer script for use in acquiring an image data item to be transferred to the first server apparatus from the acquired list of image data items to thereby transfer the acquired image data item; and
acquiring the image data item stored in the second server apparatus and transferring the acquired image data item to the first server apparatus, using the acquired transfer script.
